(19) United States
(12) Patent Application Publication
(10) Pub. No.: US 2011/0274875 A1
(43) Pub. Date: Nov. 10, 2011

(54) PASSIVE DRAG MODIFICATION SYSTEM

(75) Inventor: Amy Warncke Lang, Tuscaloosa, AL (US)

(73) Assignee: The University of Alabama, Tuscaloosa, AL (US)

(21) Appl. No.: 13/130,448

(22) PCT Filed: Nov. 23, 2009
(86) PCT No.: PCT/US09/65539

§ 371 Date: Jul. 26, 2011

Related U.S. Application Data
(60) Provisional application No. 61/116,930, filed on Nov. 21, 2008.

(51) Int. Cl. F15D 1/12; B32B 7/00; F15D 1/06; B32B 3/00

(52) U.S. Cl. 428/119; 428/141

(57) ABSTRACT

The present invention is directed to a micro-array surface that provides for drag reduction. An aerodynamic or hydrodynamic wall surface that is configured to modify a fluid boundary layer on the surface is provided. The wall surface has at least one array of micro-cavities formed therein the surface. In various examples, the interaction of the micro-cavities with the boundary layer of the fluid can control separation, reduce surface drag, and/or delay transition of the fluid over an identical smooth surface without the micro-cavities.

### CROSS-REFERENCE TO RELATED APPLICATIONS

This application claims priority to U.S. Provisional Application No. 61/116,930, filed on Nov. 21, 2008, which is incorporated in its entirety in this document by reference.

### FIELD OF THE INVENTION

An improved apparatus for reducing or enhancing the skin friction drag of an aerodynamic or hydrodynamic surface, and in particular to an improved micro-array surface design for reducing or enhancing the skin friction drag coefficient and/or heat transfer rate of aerodynamic or hydrodynamic surfaces.

### BACKGROUND

The promise of drag reduction over solid surfaces in high Reynolds number flows is one that has captured the attention of researchers for years, yet has remained illusive. In the past, numerous approaches have used both passive and active methods to control the flow in a turbulent boundary layer. In one exemplary approach, it is relatively well known that the aerodynamic drag of a surface may be reduced by applying a microscopic “texture” to the otherwise smooth surface. Although the exact fluid dynamic mechanism at work in this drag reduction is not well understood, it is speculated that the reduction relates to controlling the turbulent vortices in the boundary layer adjacent to the surface. The microscopic texture reduces the skin friction drag of solids moving through fluids (e.g., aircraft, ships, cars, etc.), and of fluids moving along solids (e.g., pipe flow, etc.).

One well known geometric form for a microscopic, friction-reducing texture is known as “riblets.” Conventionally, riblets are positioned on a surface to form an integrated series of groove-like peaks and valleys with V-shaped cross-sections. Normally, the riblets are positioned to extend along the aerodynamic surface of the object in the direction of fluid flow. In one example, the height of the riblets and the spacing between the riblets are usually uniform and on the order of 0.001 to 0.01 inches for most applications.

Dimensionless units, sometimes referred to as wall units, are conventionally utilized in describing fluid flows of this type. The wall unit h+ is the non-dimensional distance away from the wetted surface or more precisely in the direction normal to the surface, extending into the fluid. Thus h+ is a non-dimensional measurement of the height of the riblets. The wall unit s+ is the non-dimensional distance tangent to the local surface and perpendicular to the flow direction, thus the non-dimensional distance between the riblets. In the prior art riblets, h+ and s+ are in the range between 10 and 20. Exemplary riblet designs can comprise an adhesive film applied to a smooth solid surface or alternatively, with advanced manufacturing techniques, the same shapes may be directly formed and integrated into the structure of the aerodynamic surface.

The interaction of riblets with the structure of the turbulent boundary layer of the fluid reduces the skin friction drag coefficient (Cdf) of the surface by approximately 6% compared to an identical smooth surface without riblets. This reduction occurs despite the significant increase in “wetted area” (the surface area exposed to the fluid stream) of a riblet-covered surface over a smooth surface. In attempts to further reduce the Cdf, modifications to conventional V-shaped riblets have been proposed. Examples include rounding of the peaks and/or valleys of the respective riblets, as well as even smaller V-shaped notches in the sides of the larger V-shaped riblets.

Further examples of improved riblet designs that decreases skin friction drag with less concomitant increase in wetted area than conventional riblets include the use of a series of parallel riblets that extend longitudinally from a smooth surface. In this example, the riblets have a triangular cross-section in the transverse direction in which the apex of the cross-section defines a continuous, undulated ridge with peaks and valleys that causes an effective reduction in Cdf. The wetted area of this exemplary design is increased less than with conventional riblets.

### SUMMARY

Embodiments of this invention provide a surface of an object that is configured to provide for either drag reduction or enhancement, with the latter being beneficial in applications where increased turbulent mixing is desired such as in heat transfer applications. In one aspect, an aerodynamic or hydrodynamic wall surface that is configured to modify a fluid boundary layer on the surface comprises at least one array of roughness elements disposed on and extending therefrom the surface. In one example, the interaction of the roughness elements with a boundary layer of fluid can act to reduce the skin friction drag coefficient of the surface over an identical smooth surface without the roughness elements.

In a second embodiment, a method for a reduction in skin friction drag comprises an array of three-dimensional micro-cavities. In one aspect, an array of stable, embedded cavity vortices within a micro-roughness surface geometry is formed that produces a three-dimensionally patterned partial slip condition over the surface. This complex boundary condition passively forces the boundary layer flow and results in sub-laminar skin friction. In another aspect, the formed boundary condition can act to delay transition to turbulence within the boundary layer. Features of the transition process from a laminar to a turbulent boundary layer can occur in small scale flow structures close to the wall. These structures can be altered by the presence of the partial-slip boundary condition due the presence of the micro-cavities.

Other systems, methods, features, and advantages of the drag modification system of the present application will be or become apparent to one with skill in the art upon examination of the following figures and detailed description. It is intended that all such additional systems, methods, features, and advantages be included within this description, be within the scope of the passive micro-array system, and be protected by the accompanying claims.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 shows a schematic flow model for a drag enhancing d-type surface roughness, in which downwash is shown between the counter-rotating vertex pair and upwash, that would occur on either side, is shown on the front region of the surface roughness.

FIG. 2 shows a schematic flow model for a drag reducing d-type surface roughness, in which outflow, as depicted by the arrows, from the upstream cavity to the adjacent neighboring downstream cavity occurs through the valleys in the saw tooth geometry of the formed ridges.

FIG. 3 shows a schematic front elevational view of one embodiment of a ridge of an array of roughness elements. In one aspect, for drag reduction, the elements can be aligned such that the peaks of the roughness elements of each adjacent ridge can be staggered and can be spaced at about half the peak height of the roughness element. In this view, flow will encounter the ridge by moving into the figure. In one exemplary aspect, the spacing between the peaks of the adjoined roughness elements is on the order of about 30 viscous length scales at close to maximum velocity for the fluid passing over the wall surface.

FIG. 4 is a side elevational schematic view of the exemplary micro-array of roughness elements shown in FIG. 3, showing the tops of the roughness elements of FIG. 3 and showing the formation of counter-rotating streamwise vortices due to the staggered alignment of adjacent rows of the roughness elements in the drag enhancing case. The flow of fluid is directed into the figure.

FIG. 5 is a top elevational schematic view of exemplary vertex structures that form within the transversely extending cavities of an exemplary micro-array of roughness elements of FIG. 3, showing fluid flow moving from the bottom to the top of the figure and showing dark short lines correspond to the peaks of the roughness element in FIG. 3.

FIG. 6 is a perspective view of one embodiment of a roughness element of a micro-array of the present application, showing riblets formed on a front, upstream surface of the roughness element.

FIG. 7 is a side elevational view of the roughness element of FIG. 6.

FIG. 8 is a top elevational view of the roughness element of FIG. 6.

FIG. 9 is front, upstream elevational view of a plurality of adjoined roughness elements of FIG. 6 that form a ridge, and showing a plurality of channels formed between portions of the respective bases and the bottom portions of the peripheral edges of the respective adjoined roughness elements.

FIG. 10 is a perspective view of a portion of a micro-array, showing a plurality of staggered rows of the formed ridges of adjoined roughness element of FIG. 8, and showing the approximate spacing between the rows of ridges to be approximately half the height of a roughness element.

FIG. 11 is a schematic diagram of cavity flow of representative fluid flow between the tops of roughness elements of FIG. 6 and across one “valley,” the roughness elements being positioned in adjacent ridges or rows. In this diagram, fluid flow over the surface is from left to right.

FIG. 12 is a top elevational schematic view of exemplary vertex structures that form on an exemplary micro-array of roughness elements of FIG. 6, showing fluid flow moving from the left to the right of the figure. The orange vortices represent the outer vortices shown in FIG. 11 and can have small counter-rotating vortices superimposed on the outer-vortices that make the flow field consistent to its neighboring vortices. In the exemplified aspect with three riblets on the front face of the roughness element, two counter-rotating vortices would form with an upwelling between them and a downwash to the flow at the sides. These vortices are also known as Taylor-Gortler vortices. The blue vortex tubes represent the vortex cores to the vortex array that link all the individual outer cavity vortices together.

FIG. 13 is a graphical illustration of a two-dimensional computational fluid dynamics (CFD) numerical calculation through a line of symmetry over the peaks and valleys of the roughness elements in drag reduction mode. The cavity Re for this calculation is 2000, and the formation of stable cavity vortices is observed.

FIG. 14 is a graphical illustration of the velocity profiles in the boundary layer forming over the surface in FIG. 13 above the third and eighth cavities. These profiles are compared to that of a flat plate boundary layer, known as the Blasius solution. One can observe the non-zero velocity over the surface of the cavities due to the embedded cavity vortex. One skilled in the art will appreciate that one can obtain the momentum thickness of the two boundary layers, which is proportional to the total drag coefficient on the plate from the leading edge to that corresponding downstream distance, by integrating these velocity profiles. In one example, the momentum thickness over the third cavity is 16.09% of the momentum thickness of the flat plate Blasius solution, while at the eighth cavity the percentage of the momentum thickness of the surface with cavities with respect to the flat plate solution is 23.91%. Thus, at the third and eighth cavity, the drag coefficient is reduced by 84% and 76% correspondingly.

FIG. 15 illustrates isocontours of streamwise velocity in a laminar flow just over one open cavity in a periodic array. Upstream of the cavity the flow is uniform. Over the cavity, the flow speeds up as there is little viscous drag. The speed-up in fact begins about one cavity width, h, upstream and extends laterally by a fraction of h. The isocontours of streamwise velocity are at a height of 0.1 h above cavity surface in a laminar flow and the slot width Re=4 is based on the peak streamwise velocity in the slot exit plane.

FIG. 16 shows a perspective view of an exemplary honeycomb patterned micro-cavity surface.

FIG. 17 shows a partial cross-sectional view of the honeycomb patterned micro-cavity surface of FIG. 16 taken across line 17-17. This example showing the wall of the cavities configured with a parabolic profile such that the edges of the cavities are minimal in size.

FIG. 18 shows an offset, cubic micro-cavity pattern showing the partial slip pattern (in grey with a green arrow) boundary condition created by the induced flow of the embedded vortices. This illustrates the corresponding partial slip field to which the outer flow is subjected to an exemplary three-dimensional array of micro-cavities embedded in the wall surface (the three-dimensional array of micro-cavities being shown exemplarily as an offset, square patterned micro-cavity field). The complex partial slip condition pattern can be designed, via the geometry and sizing of the cavities, to disrupt the formation of high and low speed streaks in the near wall layer that lead to the transition to turbulence in the boundary layer.

FIG. 19 shows a typical convergence pattern of skin-friction lines leading towards a three-dimensional separation line. When three-dimensionality is added to the separation flow kinematics, boundary layer separation does not always coincide with a point of zero shear stress at the wall. In fact, the shear stress can vanish only at a limited number of points along the separation line, and a convergence of skin-friction lines onto a particular separation line is required for separation to occur.

FIG. 20 shows the theorized cavity vortices which should form between adjacent roughness elements for angled configurations. In this example of a passive micro-roughness array with preferential flow direction, transverse triangular roughness elements extend into the flow at an angle between 0 and 90 degrees. The figure illustrates an exemplary array of roughness elements in which the crown of each respective roughness element is positioned at an angle of about 40 degrees with respect to the flow. Preferred flow direction is from left to right in the figure and the red lines represent embedded vortices that would form between adjacent roughness elements.

FIGS. 21A-B show an exemplified micro-array of roughness elements built for water testing.

FIG. 21C shows fluorescent dye visualization of embedded vortices forming in the exemplary roughness surface shown in FIGS. 21A and 21B.

FIGS. 22A-22C show velocity vectors of flow over the model shown in FIG. 21A. FIG. 22A shows the laminar boundary conditions; FIG. 22B shows the top view of the laminar boundary layer; and FIG. 22C shows a side view of the turbulent boundary layer.

FIG. 23 is a side elevational schematic view of an array of roughness elements, according to another embodiment, showing the roughness elements positioned at an acute angle relative to the underlying surface.

FIG. 24 is a side cross-sectional view of a model for creating a cavity, according to one embodiment.

FIGS. 25A-B illustrate two orientations of a hexagonal cavity model, according to one embodiment.

FIGS. 26A-B illustrate fluid entrance and ejection points of the hexagonal cavity model of FIGS. 25A-B.

FIG. 27A is a side cross-sectional view of a vortex of a cavity, according to one embodiment.

FIG. 27B is a top plan view of vortices of a cavity, according to one embodiment.

FIG. 28 is a photograph of the vortices of FIG. 27B.

FIGS. 29-30 show partial slip velocities above each cavity for the two orientations of the hexagonal cavity models of FIGS. 25A-B.

FIGS. 31-32 show Reynolds stress above each cavity for the two orientations of the hexagonal cavity models of FIGS. 25A-B.

FIG. 33 shows the maximum Reynolds stress above each cavity for the two orientations of the hexagonal cavity models of FIGS. 25A-B.

FIG. 34 shows profiles of the Reynolds stress magnitudes at three downstream distances for the two orientations of the hexagonal cavity models of FIGS. 25A-B.

FIG. 35 shows the time averaged velocity profiles for the two orientations of the hexagonal cavity models of FIGS. 25A-B.

FIG. 36 shows the partial slip velocity over square transverse cavities, according to one embodiment.

FIG. 37 shows the boundary layer profiles extracted at the midpoint above selected cavities of FIG. 36.

FIG. 38 shows the shear stress across an embedded square cavity.

FIG. 39 shows the Re versus the % difference drag coefficient for an embedded square cavity, according to one embodiment.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise. Thus, for example, reference to “a roughness element” includes arrays of two or more such roughness elements, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

The present invention can be understood more readily by reference to the following detailed description of embodiments of the invention and the Examples included therein and to the Figures and their previous and following description.

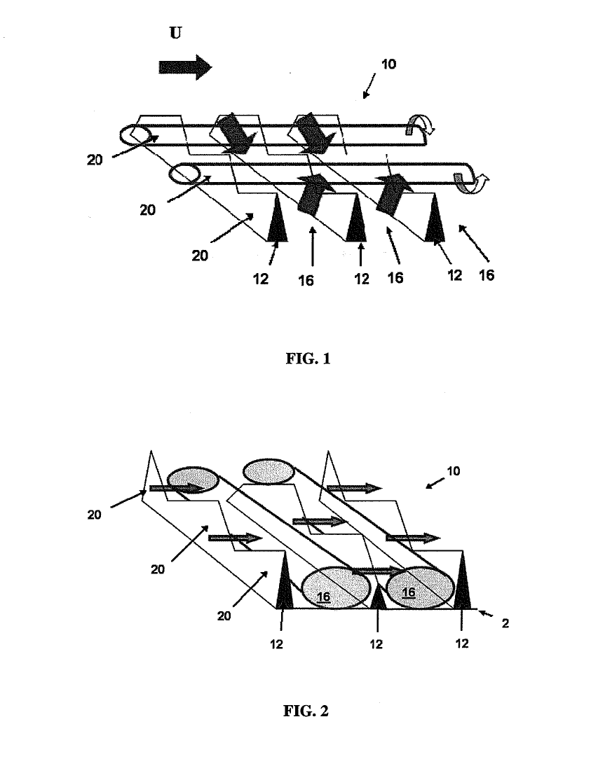

Referring to FIG. 1, an array 10 of roughness elements with the induced flow field is illustrated. As shown, spanwise or transverse cavities 16 defined between the ridges 12 that are exemplarily formed from adjoined roughness elements 20 that are positioned substantially transverse to the flow of the fluid over the surface 2, which results in a series of cavity flows, each containing a re-circulating flow field. In the exemplary embodiment illustrated in FIGS. 1 and 2, roughness elements 20 are integrally connected together to form individual ridges 12 that are positioned on and extend from the surface 2 substantially transverse to the flow of fluid across the surface 2. In one aspect, the ridges 12 are spaced substantially uniform and, optionally can be variably spaced.

In one aspect, due to the spacing of the saw tooth peaked roughness elements 20, an on average streamwise vortex forms in the flow above each cavity, such as found in the case of drag enhancing riblets. In one aspect, it is contemplated that the cavities would comprise vortices of alternating sign as this would appear to provide the most stable flow regime. In this aspect, and as illustrated, neighboring vortices contribute to upwashes and downwashes in an alternating manner across the spanwise direction.

One skilled in the art will also appreciate that alternative shapes of the roughness elements 20 are contemplated. Exemplary alternative shapes can comprise, but are not meant to be limited to, a blade-like thin peak, which allows the formation of an increased number of vortices in a predetermined spanwise dimension, a trapezoidal cross-sectional shape with a flat portion of the ridge over which the vortices will form, and the like.

Independent of the ideal shape of the ridges 12, the overall characteristics of the flow field remains unchanged. In operation, and referring to FIG. 1, a fluid particle would enter from the left at some distance above the surface 2, such as exemplary shown as a flat plate. As the fluid particle approaches the surface it feels the presence more of the counter-rotating vortex pair and is pulled downward into a region of downwash. As it enters this downwash, the fluid particle enters the cavity 16 and is spun around, in an almost slingshot type motion, and injected back out above the surface through an upwash region of the channels. From a heat transfer standpoint, the proposed surface causes fluid particles far away from the surface to come in contact (or very near) to the surface for a short period of time and then to be pushed out again far above the surface. With this “on average” flow field, the burst/sweep process has been accentuated and controlled to take place in an organized manner. Thus, in one aspect, the exemplary array 10 of roughness elements 20 provides an efficient manner by which a turbulent boundary layer flow can be optimized for convective heating/cooling purposes over a solid surface.

In one exemplary aspect, in order to cause as much fluid as possible to come in contact with the “rough” surface 2, the spacing between the transverse cavities 16 should be minimized. However, if the spacing became too small, the mass flow rate pumped through the cavities would decrease due to viscous effects. In one exemplary aspect, the average height of the ridges (h⁺) is substantially equal to the width of the cavity (w⁺), or is about a one to one height to width ratio (h⁺≈w⁺). In another aspect, with respect to the average height of the cavities, it can be greater than about half the peak-to-peak amplitude of the saw tooth pattern along the ridges. In an exemplary aspect, the amplitude for riblet spacing would be about and between 10 s⁺ to 20 s⁺. In another example, the amplitude would be about 15 s⁺. In this aspect, this would also be the average height of the ridges, with the minimum valley point of the ridges located at an elevation of s+ that is about 7.5 (±2.5) above the bottom of the cavity, and maximum peak located at s⁺ that is about 22.5 (±2.5).

In a further aspect, the wavelength of the saw tooth pattern can be about λ⁺=40, based on the size of a typical vortex mentioned previously of s+ being about 30. This would be sufficient to hold a vortex between the peaks. Of course, it will be appreciated that these dimensions are exemplary only and are not meant to be limiting. Further, one will appreciate that the exemplary dimensions can be scaled as desired.

Referring now to FIG. 2, an exemplary flow field through the drag reducing roughness element 20 is illustrated. It has been demonstrated that a series of transverse cavities 16 with substantially constant ridge height is prone to a random efflux/influx of fluid due to the high shear region located above the cavities. This high shear region results in the formation of streamwise vortices and low speed streaks above the cavities such as found in the smooth surface case. It is likely that the peak velocity can be larger for cavities 16 formed by a series of transverse blades, but would more than likely still be a large enough percentage below the freestream that streamwise vortices would still be formed due to a high shear region above the cavities. As shown in FIG. 2, to prevent and/or reduce the efflux/influx process out/into the cavities, a saw tooth geometry is defined by the respective roughness elements 20 that form the ridges 12 of the array of roughness elements.

In this example, the substantially transverse cavities formed between the adjacent ridges help with the stability of the flow field as the flow through the cavities is given a longer distance (two cavity widths as opposed to one) by which it is exposed and pulled along by the flow directly above. As a result of the exemplary geometry, the estimated peak velocity achieved is in a range between about 5 to 40 percent of the freestream flow. Second, the jets formed through the cavities are substantially tangent to the flow above so that very little vertical velocity component is formed. If one were looking down onto the surface, the formed jets would appear to be a periodic array of suction and blowing at a smooth wall. Finally, the flow acting on the bottom of the cavities results in a shear stress that provides thrust to the surface. In this case the effect is such that it can act to cancel out a large percentage of the skin friction losses due to the momentum change in the flow over the vertical walls of the cavities. It is contemplated that this effect is more pronounced as higher peak velocities in the jets (and thus closer to the bottom surface of the cavities) are achieved. Thus, in one example, the width of the cavities 16 can be increased or maximized (such that the stable flow field in FIG. 2 is maintained) so as to decrease the number of spanwise channels over a given surface area.

In this aspect, considering an averaged streamline through the roughness element 20, a fluid particle that starts from the left close to the surface would approach a transverse cavity in the array and upon entering the cavity be captured by the cavity vortex and travel around in a spiral motion before being passed through another cavity just to enter the neighboring cavity and repeat the previous motion. In this example, all fluid near the ridge stays near the ridge and there is little or no on average vertical velocity component away from the cavities of the array. Given the flow model as stated, and that the cavities are dimensionally small enough such that viscous effects dominate, it is contemplated that the net skin friction drag over such an exemplary surface could start to approach that of a laminar flat plate boundary layer.

In one aspect, the formed “rough” surface can be categorized as a series of trapezoidal channels (d-type roughness geometry) that are orientated in the spanwise direction (transverse to the flow of fluid across the array), but, in one exemplary aspect, with a saw tooth geometry of alternating peaks along the ridges of the channels giving the surface a three-dimensional, yet repeatable, pattern. The alignment of the peaks in the streamwise direction of the flow of fluid is proposed to increase drag, while the alternation of the peaks in the streamwise direction will decrease drag. In one aspect, the spacing between the ridges 12 in the streamwise direction can vary from ½ to a full value of the peak height (or amplitude) of the ridges with respect to the bottom of the cavities. In another aspect, the distance between adjacent successive ridges can be in a range of between about 40 to 60% of the peak longitudinal height or amplitude of the roughness elements that form the respective ridges. Optionally, the distance between adjacent successive ridges can be in a range of between about 45 to 55% of the peak longitudinal height or amplitude of the roughness elements that form the respective ridges

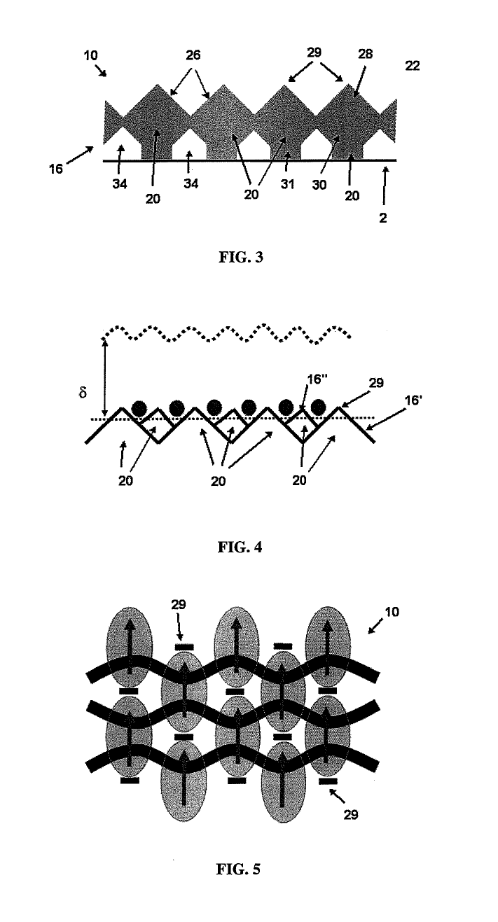

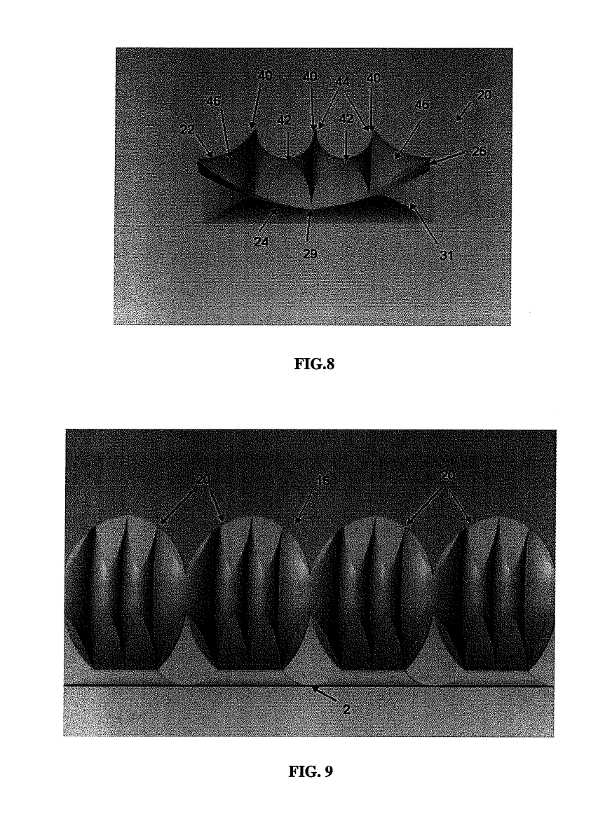

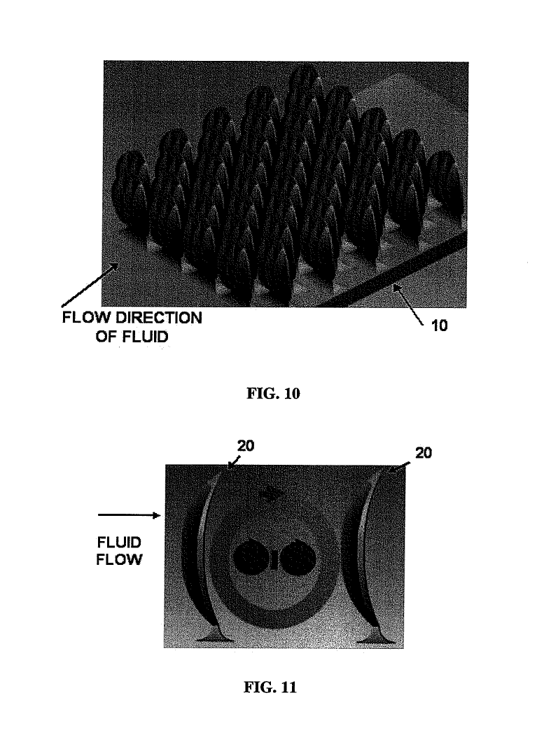

In an alternative embodiment, and referring now to FIGS. 3-12, the micro-array 10 can comprise a plurality of roughness elements 20 that can extend from the surface and be positioned in spaced ridges along the surface 2. In this aspect, it is contemplated that each roughness element 20 has a front, upstream surface 22 and an opposing rear, downstream surface 24. Further, each roughness element has a peripheral edge 26 that has an upper portion 28 that tapers to a top 29 and a bottom portion 30 that tapers to a base 31. As one would appreciate, the base is configured to be connected to the underlying surface 2 of the object. In one exemplified aspect, the roughness elements 20 are positioned on the underlying surface 2 substantially transverse to the flow of the fluid across the surface. In another aspect, the roughness elements extend substantially normal to the underlying surface. For example, and not meant to be limiting, the transverse longitudinal height of the roughness elements can be between about 0.001 to 2.00 cm.

In one aspect, a plurality of roughness elements 20 can be positioned transverse to the flow of fluid across the surface such that a distance between a medial portion 32 of the peripheral edges of adjacent and aligned roughness elements 20 is less than the distance between the respective tops 29 of the roughness elements and is less than the distance between the respective bases 31 of the roughness elements. In a further aspect, adjacent and aligned roughness elements 20 can be connected at some selected portion of the respective peripheral edges of the roughness elements. In this aspect, a channel 34 is defined therebetween portions of the bases and the bottom portions 30 of the peripheral edges 26 of the adjacent and adjoined roughness elements. In one exemplary aspect, it is contemplated that the formed channels would extend longitudinally substantially co-axial to the flow of the fluid across the surface. In an alternative aspect, the adjoining roughness elements can be connected together such that no channel is formed therebetween the respective adjoining elements. In a further aspect, the adjoined roughness elements can form a “saw tooth” ridge that extends substantially transverse to the fluid flow.

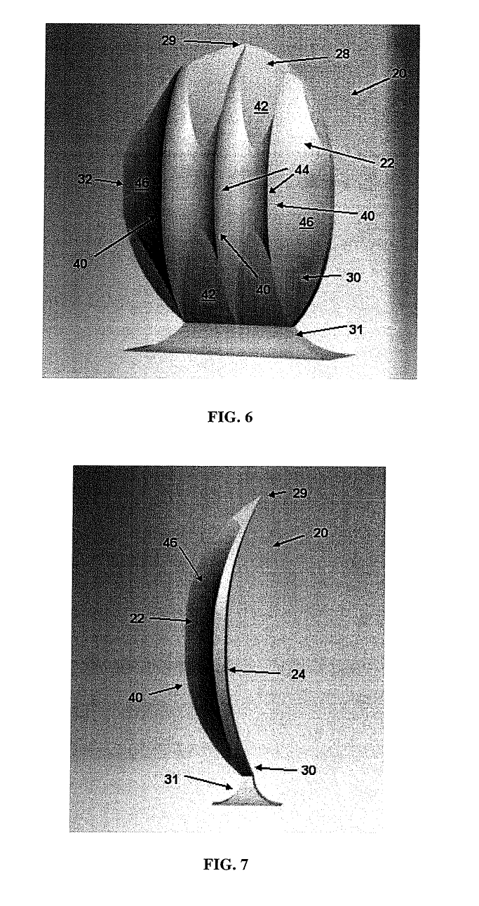

In one embodiment, the roughness element 20 has a substantially diamond cross-sectional shape, as shown in FIG. 3. Alternatively, and as shown in FIG. 6, the roughness element 20 can have a substantially oval shape. Of course, one skilled in the art will appreciate that other geometric shapes are contemplated and that the aspects illustrated are merely exemplary.

Referring now to FIGS. 6-10, in one aspect, it is contemplated that the front, upstream surface 22 of the roughness element 20 has a curved, convex cross-sectional shape relative to the flow of fluid across the surface 2 of the object. In another aspect, it is contemplated that the rear, downstream surface 24 of the roughness element has a curved, concave cross-sectional shape relative to the flow of fluid to promote the recirculation of the flow within the cavity, and to act as a streamlining effect in both stabilizing and promoting the embedded vortex flow field. In one aspect, this slight concavity in the rear surface 24 of the roughness element also acts to position the tops 29 of the roughness elements at a slight, acute angle relative to the underlying surface such that the tops of the roughness elements do not protrude into the fluid flow normal to the flow direction. In one aspect, it is contemplated that the radius of curvature of the rear surface 24 of the roughness element is less than the radius of curvature of the front surface 22 of the roughness element.

In a further aspect, each roughness element 20 can have at least one riblet 40 extending outwardly therefrom the front surface 22 of the roughness element. In one aspect, the riblet 40 extends longitudinally from at or near the bottom portion 30 of the roughness element, proximate the base 31, to at or near the top 29 of the roughness element. That is, in one aspect, the riblet extends substantially transverse to the underlying surface. If a plurality of riblets are used, it is contemplated that the ribs can be spaced apart substantially equal or at varying distances. Of course, the number of riblets 40 can vary in number, but typical values would be that from 1 to 7 per each longer wavelength of the saw tooth pattern of the formed ridge of the micro-array. In one aspect, the number of riblets is 1, 3, 5, or 7.

The presence of the riblets 40 formed to either the front surface 22, or, optionally, to both sides of the roughness element, act to give a streamlining effect that is conductive to the formation and stability of the cavity flows (or vortices) embedded within the cavities formed between adjacent ridges or rows of the roughness elements. In one aspect, the addition of the riblets to the roughness elements micro-geometry help to increase drag reduction, such as, for example, with higher speed flows. In a further aspect, the riblets 40 act to excite counter-rotating vortices within the outer vortex structure that when in even numbers (formed by an odd number of riblets) promote the stability of the vortex array in the surface.

Further, in another aspect, it is contemplated that a trough 42 is defined therebetween adjacent riblets 40 that is recessed from the respective tips 44 of the riblets. In one aspect, the trough can be formed by a smooth, curved surface. Of course, it is contemplated that the surface of each of the troughs in the respective roughness element can have a substantially equal radius of curvature or can vary as desired.

In another aspect, the riblets 40 have an edge surface 46 that extends between the respective riblets that are adjacent to the sides of the roughness element. In one aspect, the edge surface 46 can be substantially planar. Alternatively, at least a portion of the edge surface can be curved. In the curved aspect, it is contemplated that the radius of curvature of the edge surface can be greater than the radius of curvature of the troughs 42 of the roughness elements.

It is further contemplated that the geometry of the formed surface can be altered as a function of the thickness of the boundary layer adjacent to the surface. For example, in regions where the boundary layer is thicker, the tops 29 of the roughness elements 20 can also comprise an additional saw tooth pattern of shorter wavelength superimposed on the larger wavelength saw tooth pattern. This is of importance in regions far downstream from the leading edge of a body where the boundary layer is thicker, yet the flow outside the boundary layer and above the surface is of high velocity.

In a drag reduction mode, the saw tooth pattern on the tops 29 of the roughness elements 20 acts to inhibit the formation of the optimal perturbations that appear due to the instability of the shear flow (or boundary layer) above the roughness element and inside the boundary layer. At lower speeds this wavelength is larger. Conversely, at higher speeds this wavelength is smaller. In one exemplary aspect, the smaller wavelength superimposed on the larger saw tooth tops can vary from between about ⅓ to 1/7 that of the larger wavelength. The sizing is a function of the speed of the flow outside the boundary layer adjacent to the surface (U), the kinematic viscosity of the fluid (ν) and the maximum shear in the boundary layer ((du/dy)ₘₐₓ). It should be noted that as a body moves at higher speeds, the boundary layer at a particular point on the body will reduce in thickness and the maximum shear sustained in the boundary layer will increase. This corresponds to a decrease in the wavelength sizing required of the roughness element to act in drag reduction mode.

Regardless of whether a surface results in the formation of embedded vortices within the respective roughness elements or not, the “male protrusions” that result from the roughness elements and their sizing can be sufficient enough to delay the transition to turbulence in the boundary layer and thus still result in drag reduction. However, to maximize the drag reduction characteristic of the micro-array of roughness elements of the present invention would include both the formation of the embedded spanwise vortex array within the roughness element as well as the protrusion geometry of the roughness geometry, which leads to the damping of instabilities in the boundary layer that result in the transition to turbulence.

In addition, and as noted above, the downstream side of the roughness elements can, or can not, comprise a slightly concavity to the surface (see FIG. 7) as well. This thickness to the peak of the formed ridge provides a smooth line of reattachment for the separated shear layer over the top of the cavity from the previous upstream roughness element and at the top of the roughness element provides for a tangential meeting of this outer flow with the next downstream embedded cavity vortex (again, see FIG. 7). All of the elements listed here have to do with the effects of streamlining the micro-geometry to promote the formation of a stable, embedded cavity vortex within the roughness element.

Further, it is contemplated that the micro-array 10 of roughness elements 20 on the surface 2 can comprise a plurality of micro-arrays of roughness elements 20 on the respective surface 2. In this aspect, each micro-array can comprise a plurality of roughness elements, as described above, of a predetermined height and/or shape. Thus, it is contemplated that, the plurality of micro-arrays could comprise arrays of varying sized or shaped roughness elements.

In another aspect, each micro-array of roughness elements can comprise individual roughness elements that vary in respective scale and/or shape. For example and not meant to be limiting, adjacent roughness element could have different relative scaled dimensions. Thus, a “large” roughness element can adjoin a “small” roughness element, such that a front view would be of a line or ridge of the adjoining roughness elements that have a staggered saw tooth appearance.

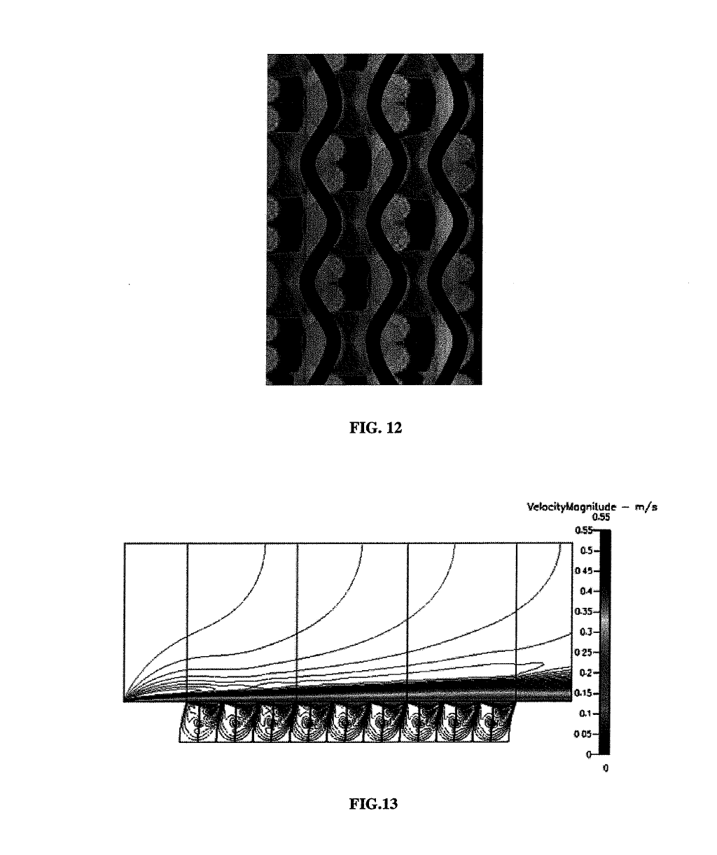

In the arrays discussed above, the formed channel 34 between adjoining roughness elements 20 allows for some of the reversed flow at the bottom of the cavities between adjacent span-wise extending ridges of lines of the roughness elements to head back upstream to the adjacent, neighboring cavity through the channels between the roughness elements. In operation, a cavity flow can result such that fluid particles stay in the cavities to continue the circulatory pattern between the two cavities, i.e., entering the downstream cavity over the top of the valley to return back to the upstream cavity through the gap beneath the valley as shown in FIG. 11. The juncture of the two adjoining roughness elements acts as a center for each individual cavity vortex and can also allow for a secondary pair of vortices to form inside the larger cavity vortex, which is also shown in FIG. 11. Referring to FIG. 12, these vortices, one inside each transverse half cavity, provides a means of interlocking all of the cavity flows together in an almost chain-link type array of streamlines that are relatively stable and are not subject to cavity influx/efflux of flow, which leads to an increase in drag for the d-type surface. As noted above, the micro-geometrical patterning of a surface in this embodiment for maximum drag reduction mode results in the formation of an array of embedded cavity flows (or vortices) between the roughness elements.

It is contemplated that the flow arranged by this roughness element is a series of micro-slip walls in which the orange ovals in FIG. 12 denote each micro-slip wall. From another standpoint, it is contemplated that the roughness element of the present invention alters the no slip condition which the outside flow sees at the wall. Further, it is known that embedded cavity flow can be used as a means of separation control due to the alteration of the no-slip condition at the surface. It is contemplated that the roughness element described herein can be used in applications that would reduce the pressure drag associated with separated flows over surfaces.

In a further aspect of the “roughness” surface, the thickness of the boundary layer can be in a range of at least 10 to 30% of a cavity height of each cavity such that shear layer instabilities of cavity vortexes that form therein the plurality of cavities are reduced. Preferably, the thickness of the boundary layer is about at least 20% of the cavity height. Typically, cavity height would be measured from the surface 2 of the object to the peak or highest amplitude of the roughness elements that form the transversely disposed ridge. In one aspect, each formed cavity vortex can have a Re, relative to the cavity height, velocity of the fluid over the wall surface, and the kinematic viscosity of the fluid, in the range of between 100 and 20,000, such that the instability of the formed cavity vortexes are suppressed. Optionally, each formed cavity vortex can have a Re, relative to the cavity height, velocity of the fluid over the wall surface, and the kinematic viscosity of the fluid, in the range of between 1,000 and 5,000.

The micro-arrays of the roughness elements of the present invention would find applicability in drag reduction modalities, such as, for example and not meant to be limiting, on the surfaces of aircraft, submarines, ship hulls, high speed trains and the like. In the case of the flow over the hull of a ship, the micro-arrays of the roughness elements can impact the boundary layer formation over the hull and therefore affect the amount of air ingested below the water line, thereby altering the entire flow field of a ship's wake. It is also contemplated than the micro-arrays can be used in pipeline walls as well, which would result in a large reduction in the amount of energy saved to pump fluids from one point to another.

It is also contemplated that the micro-arrays of the present invention allows for the trapping of pockets of air inside the cavities such that, for example, in hydrodynamic applications, the working fluid for the micro-slip walls would consist of these air pockets. This would also reduce the skin friction for hydrodynamic applications and, in another aspect, can reduce cativation.

Still further, the micro-arrays of roughness element can act as a means of controlling separation. The effect of the arrays acts to reduce pressure drag over bluff bodies such as automobiles and trucks. It can also minimize separation over turbine blades, airfoils, and helicopter rotors as well as flow through serpentine ducts, which is often a requirement for inlet geometries for engines on an aircraft. Optionally, in a drag enhancement mode, a surface formed with the micro-array of roughness elements of the present invention allows for highly effective convective cooling to the surfaces of computer board components, which could greatly impact the performance of these devices.

It is also contemplated that the self-cleaning property of the roughness elements should be excellent due to the high shear rates resulting over the major portions of the surfaces of the roughness elements. However, it is also contemplated to use hydrophobic materials in constructing the roughness elements for hydrodynamic applications.

It is contemplated that a surface formed with a micro-array of roughness element as described above, could be formed for a saw tooth wavelength that corresponds to that of the optimal perturbation wavelength for the shear flow inside the boundary layer. In this example, the alignment or alternation of the peaks to achieve maximum heat transfer rates and maximum drag at a surface is considered. In one aspect, the alternation of the peaks forces the half-wavelength of the saw tooth amplitude to correspond to the optimal perturbation wavelength. Thus, it is contemplated that the formed drag reducing surface could become drag enhancing as the flow speed is increased.

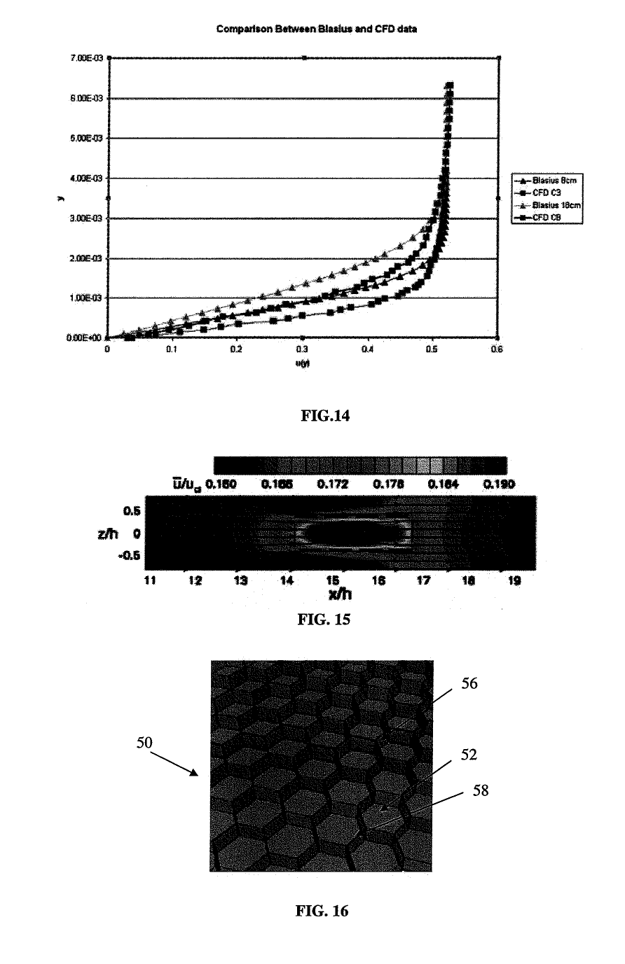

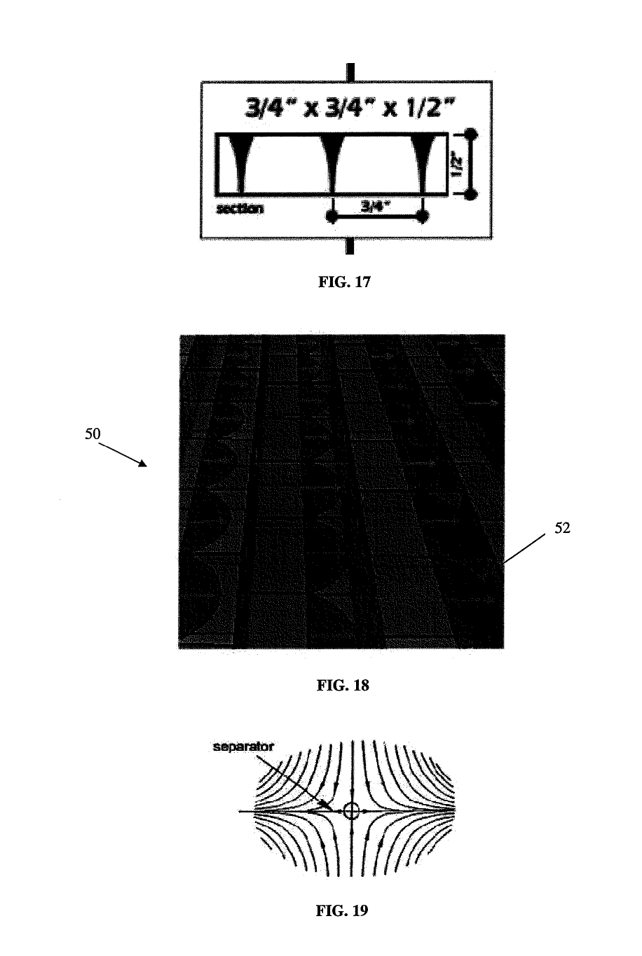

Referring now to FIGS. 15-18, in an alternative embodiment, a method for reduction in skin friction drag comprises an array of three-dimensional micro-cavities that are configured to form an array of stable, embedded cavity vortices such that a three-dimensionally patterned partial slip condition is produced over the surface. This complex boundary condition passively forces the boundary layer flow and results in sub-laminar skin friction. In another aspect, the formed boundary condition can act to delay transition to turbulence within the boundary layer.

Reduction in skin friction drag over a surface can be achieved by delaying the transition of the boundary layer from the laminar to turbulent state. This is due to the fact that a laminar boundary layer has significantly lower shear stress at the surface than a turbulent one, and attempts to delay transition are labeled as laminar flow control (LFC). The typical method to maintain laminar flow is through the use of suction. Alternatively, discrete roughness elements (DRE) can be used. It has been found that, through the use of small cylindrical DRE strategically located on the surface of a plate, Tollmien-Schlichting (TS) instability waves that are known to lead to natural transition in a flat plate boundary layer can be suppressed. This can be achieved due to the formation of steady, optimal low and high speed streaks across the boundary layer of moderate amplitude, which are found to suppress the instabilities forming on the TS waves that lead to the formation of turbulent spots. It has also been shown that roughness elements, spaced with spanwise wavelengths shorter than that corresponding to the most amplified disturbance in the boundary layer, can act as a means of delaying transition in the case of swept wing boundary layers whereby the cross-flow instability is suppressed.

It is contemplated that the negative effect of enhanced receptivity for a two-dimensional ribbed roughness that is typically observed can be attributed to the amplification of TS instability waves by a periodic 2-D forcing from variation in the shear stress as the flow passes over the tops of the roughness elements. In one aspect, it is contemplated that a 3-D periodic forcing can be imposed by the roughness elements. In another aspect, significant sub-laminar drag over the surface can be achieved by minimizing the separation distance between the cavities (with the surface being substantially structurally sound). Further, the methodology can act to reduce the boundary layer receptivity and delay transition. In one preferred aspect, the surface is specifically patterned to facilitate interference with the growth process of the most unstable waves.

In one aspect, the methodology contemplates the use of a cavity having a substantially constant depth. The constant depth cavity helps to form and maintain a stable cavity flow, with no influx/efflux of fluid.

In another aspect, a microgeometry 60 is formed in the surface that is exposed to the flow of fluid. In one example, the microgeometry can comprise a three-dimensional array 50 of micro-cavities 52 such that the cavity Re remains small (about on the order Re=2000) and the boundary layer forming over the cavity is sufficiently thick. Such a formed microgeometry insures that the centrifugal instability, leading to the formation of Taylor-Gortler vortices, in the cavity flow as well as any instability of the shear layer (Kelvin-Helmholtz instability) forming over the cavity openings is prevented. The result is a stable cavity flow, with no influx/efflux of fluid. The resulting partial slip condition, formed at the boundary separating the cavity flow fluid and outer flow fluid, results in reduced momentum thickness within the boundary layer.

In one experimental example, the alteration of the momentum thickness was confirmed and resulted in a reduction of drag coefficient at a distance 18 cm downstream from 0.01736 for the Blasius solution to 0.00415 sustained over the first eight cavities (75% reduction).

In various aspects, it is contemplated that the cavities of the microgeometry can comprise a substantially cubic design, a honeycomb structure, as shown in FIG. 16, and the like. These shapes are merely exemplary and no limitation on the geometric shape of the cavities of the surface is intended.

In another aspect, a method/system for facilitating a controlled point of transition in the boundary layer and/or delaying transition is provided. In one aspect, a plurality of discrete roughness elements (DRE) can be spaced in the spanwise direction of the surface at the optimal wavelength. This structure can cause streamwise vortices and low-speed streaks of sufficient amplitude (such that breakdown to turbulence will take place over a flat plate) to be generated through the transient growth mechanism.

In another aspect, a small spanwise slit is provided in the surface through which, via an alternation of suction and pumping of fluid, TS waves in the most unstable frequency range can be generated that lead to early transition. In still another aspect, an adverse pressure gradient for the flow over the boundary layer is set up such that early transition is promoted. This can be exemplarily achieved by placing the flat plate surface at a small angle of attack relative to the flow of fluid such that the flow over the flat plate is subjected to a diverging area and subsequently decelerates along the length of the plate.

One exemplary example of a three-dimensional array 50 of micro-cavities 52 embedded in the surface is shown in FIG. 18 for an offset, square patterned micro-cavity field. It is contemplated that this complex partial slip condition pattern can be configured, via the geometry and sizing of the cavities, to disrupt the formation of high and low speed streaks in the near wall layer that lead to the transition to turbulence in the boundary layer. In one aspect, the partial slip pattern favors the streamwise direction, and according to the computations of Min & Kim (2005), a surface dominated by streamwise slip has the highest potential for transition delay. Thus, the microgeometry disrupts the formation of the low-speed streaks and reduces the momentum thickness of the boundary layer. It should be noted that this higher momentum in the flow closer to the surface is favorable also in delaying separation of the boundary layer under adverse pressure gradient conditions (Gad-el-Hak, 2000).

This embodiment thus contemplates the use of a microgeometry 60 that can comprise an array 50 of cavities 52 in which embedded cavity flows form. The array 50 of cavities 52 can be configured to cause transition delay in boundary layer flows and to reduce skin friction drag. It is contemplated that the methodologies/systems of the present application that use such an embedded micro-cavity surface lead to sub-laminar boundary layer skin friction coefficients and correspondingly smaller momentum thickness. Of course, while two primary cavity geometries, cubic and hexagonal, have been discussed herein, it is contemplated that these shapes are not meant to be limiting and that other geometric shapes can be used (perhaps in combination).

In a further aspect, at least a portion of the edges 54 of cavities 52 that are substantially aligned with the flow of fluid over the surface can have upwardly extending ribs that are connected to and extend outwardly from the top edges 58 of the cavity. In another aspect, portions of a plurality of cavity walls 56 of the cavities can extend upwardly above the generalized plane of the surface to form wall extensions. In one aspect, the wall extensions can protrude into the flow of fluid above the plane of the surface only on those cavity walls 56 that were aligned with the fluid flow direction. Optionally, the wall extensions could extend partially or along the substantial length of the portion of the cavity walls that are aligned with the fluid flow direction. Further, the height of the wall extension above the generalized plane of the surface can be a multiple of the depth of the cavity. It is contemplated that this multiple can range between about 0 to about 4. It is also contemplated that the outwardly extending extensions or ribs would be beneficial in inhibiting cross-flow near the surface and perhaps cavity influx/efflux.

In one aspect, it is known that separation of the boundary layer from the body typically occurs in vicinities where the flow is decelerating due to change in body curvature, which results in an adverse pressure gradient. Thus, separation typically occurs in areas that are posterior of the maximum body thickness. Incipient separation is characterized by regions of decreasing skin friction approaching zero, and consequent reversal of the flow at the surface A similar process, known as dynamic stall, characterizes unsteady separation from a moving surface producing lift (i.e., a pitching airfoil) or thrust (i.e., an oscillating caudal fin). Unsteady separation is characterized by a locality where both the shear stress (or skin friction) and velocity approach zero as seen by an observer moving with the separation point (known as the MRS criterion). In this case, a separated region is most likely to occur near the point of highest curvature (typically near the leading edge) prior to blending with the wake near the trailing edge. If such separation occurs in the latter case, lower propulsive efficiencies typically result. However, if the unsteady separation process can be controlled, such that the leading edge separation bubble remains disconnected with the wake then an unsteady high-thrust (or high-lift) generation mechanism can occur.

In another aspect, when three-dimensionality is added to the separation flow kinematics, the boundary layer separation does not always coincide with a point of zero shear stress at the wall. In fact, and as shown in FIG. 19, the shear stress can vanish only at a limited number of points along the separation line, and a convergence of skin-friction lines onto a particular separation line is required for separation to occur. As a result, 3D boundary layers can be more capable of overcoming an adverse pressure gradient without separating. Thus, in this embodiment, it is contemplated that the respective micro-geometries of the micro-array of roughness elements are configured in a preferential flow direction. This configuration can prevent the required convergence of skin friction lines and can passively act to keep the flow attached, thereby reducing pressure drag.

As contemplated, delaying separation of the flow from a solid boundary results not only in reduced pressure drag, but also decreased pressure losses in ducted flows such as through diffusers and turning elbows. Various mechanisms by which separation can be controlled have been investigated and successfully applied in the past. Many of these techniques require the application of suction and/or blowing at the surface and require energy input.

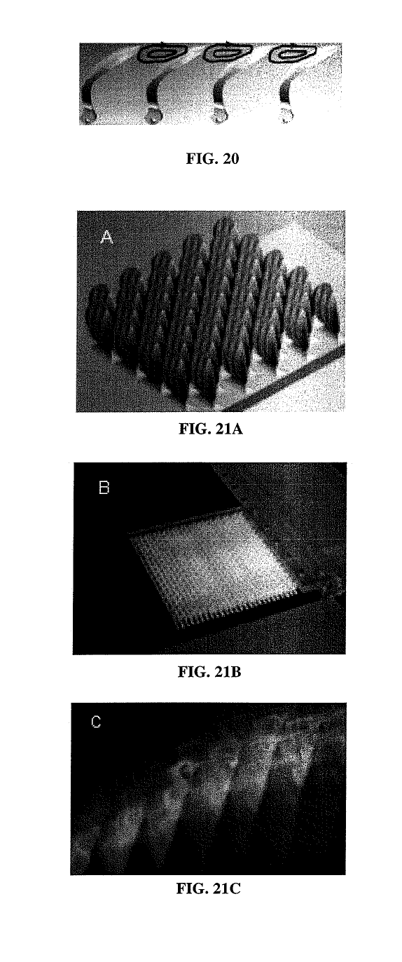

The micro-geometries of each of the roughness elements can be configured to successfully control separation. In this aspect, the micro-geometries act to impart momentum to the very near-wall region of the flow, which prevents flow reversal. This can be achieved by the formation of embedded cavity vortices as shown in FIG. 20. One of the most successful passive means to date has been the use of vortex generators, or small typically v-shaped protrusions with profiles less than half the boundary layer thickness. These have been shown to produce a system of streamwise vortices which mix high and low momentum fluid that energizes the flow close to the surface. Vortex generators need to be placed at a specific downstream location within a turbulent boundary layer for maximum performance such that the streamwise vortices affect the region where separation would normally occur.

As described above, patterned surfaces can also result in separation control and golf ball dimples present one of the most well-known illustrations of surface patterning resulting in separation control and reduced drag. However, the dimples do more than just trip the boundary layer to the turbulent state. It has been shown that the formation of embedded cavity vortices, or small localized regions of separation within the surface allow the outer boundary layer flow to skip over the dimples in the pattered surface. Thus, the use of patterned surfaces, capable of imposing partial-slip flow conditions at the wall due to the formation of embedded vortices, can achieve drag reduction via separation control.

In addition, and as contemplated herein, if a surface has a preferred flow direction, which can exemplarily be felt by moving one's hand over the surface, movement in the direction of preferred flow would feel smooth to the touch. But, when the preferred direction surface is felt in the opposite direction, a higher resistance is imposed and the surface feels rougher. Thus, this aspect acts to enhance the boundary layer control mechanism of the micro-geometries by providing a preferential flow direction of the surface that is capable of locally resisting the reversal of flow at or near the surface. Therefore, the configured surface has the potential to disrupt the convergence of skin-friction lines onto a particular separation line, which controls three-dimensional separation. The contemplated micro-array of roughness elements, with the exemplary preferred flow direction micro-geometries can aid in separation control and or transition delay.

Flow experiments have been conducted on an exemplary model array surface, shown in FIGS. 21A and 21B. In this exemplary array of roughness elements, a 16×24 array of roughness elements were scaled up from 0.2 mm to 20 mm for the model. Similarity of the cavity flow is achieved by matching the cavity Re˜2800 between real application at higher velocities and model (the scale-up in size is countered by a scale-down in velocity over the surface from 14 m/s to 14 cm/s with negligible change in viscosity). In one experiment, a long flat plate (˜180 cm) with an elliptic leading edge was used to grow the boundary layer sufficiently thick such that shear layer instabilities over the cavity vortices were not observed to develop. It has been shown that a vortex forming in a square cavity remains stable at Re=10,000 as long as the boundary layer thickness was more than roughly 20% of the cavity depth.

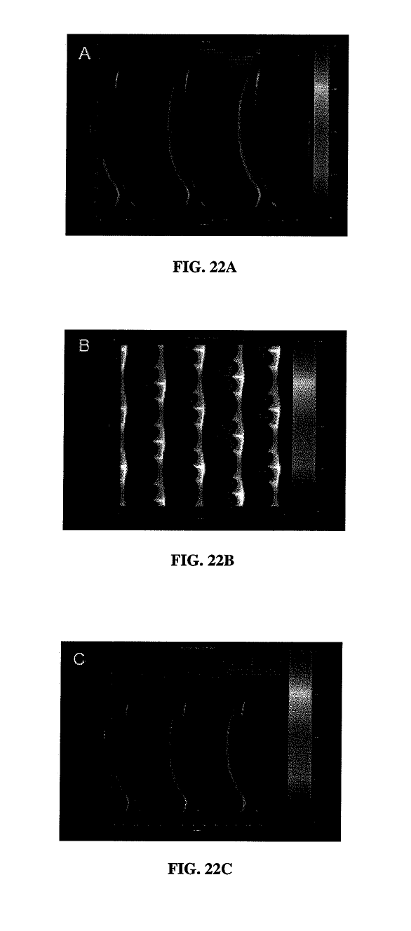

Referring to FIG. 21C, the experimental results confirmed the presence of cavity vortices within the micro-array. The results also show that with the sufficient growth of a boundary layer upstream of the model (local Re=2×10⁵), transition is not tripped by the surface and the flow skips over the cavities. Referring now to FIG. 22A-22C, a time-resolved digital particle image velocimetry system was used to capture 2D velocity data within and above the exemplified micro-array surface. In FIG. 22A, the middle roughness element corresponds to a valley in the configuration geometry, and the first and third elements to peaks. In this exemplary aspect, the flow accelerates over the cavity spanning the first and third denticles or roughness elements, with the primary formation of vorticity being measured in front of the third denticle (flow being from left to right in the figure). In this example, and as shown in FIG. 22B, the flow accelerates as it passes over the cavity between the denticles and reaches speeds on the order of 5-10% of the freestream flow (U) and has an average velocity in the y=0 plane of 0.03 U. In the purely flat surface case, the no slip condition at y=0 enforces a zero velocity boundary condition to the boundary layer flow.

It is contemplated that the flow velocity at the streamline separating the cavity flow from the outer boundary layer flow will further increase concomitantly with a decrease in the boundary layer thickness (in the current exemplary case this is about 21 mm, or roughly the same size as the cavity depth and thus a fairly thick boundary layer is used for these results). In the case where the boundary layer is tripped prior to the configured denticle model this increases to an average velocity in the y=0 plane of 0.14 U as a result of the higher momentum closer to the surface from the presence of the turbulent boundary layer above the denticle model. As shown in FIG. 22C, periodic exchange of fluid is observed in the turbulent boundary layer case between the cavity flow and boundary flow, but on average the flow displays only a streamwise component above the cavity. These results are consistent with the cavity flow exchange observed in two-dimensional transverse ribbed surfaces. Thus, it is contemplated that a micro-array of erect roughness elements leads to higher momentum in the fluid at y=0 for both laminar and turbulent boundary layer conditions which makes such a roughness surface a good candidate as a mechanism for separation control.

In one aspect, it is contemplated that the roughness elements described herein can be positioned at an angle relative to the flow of fluid across the roughness surface. The example shown in FIG. 22A illustrates an exemplary roughness element that is extending substantially normal to the flow of fluid. It is contemplated that the roughness element can be positioned at a selected angle or angles relative to the flow such that a preferential flow direction surface is formed.

Positioning the roughness elements at more acute angles will result in shallower cavity areas that are conducive to embedded vortex formation within the geometry. As the angle increases toward normal, the inter-element cavity distance between the roughness elements increases. FIG. 20 shows the theorized cavity vortices which should form between adjacent roughness elements for angled configurations. The vortices that form can be more shallow and oblong in nature than previously reported. Yet, even in very shallow circular depression roughness, such as dimples on a golf ball, the existence of a cavity vortex is found to occur even at low Re. It is postulated that the primary mechanism by which separation control is achieved is the partial slip over the embedded cavity vortices. However, small-scale mixing of fluid into and out of the cavities can also provide an additional mechanism delaying or preventing separation for turbulent or transitioning boundary layer conditions.

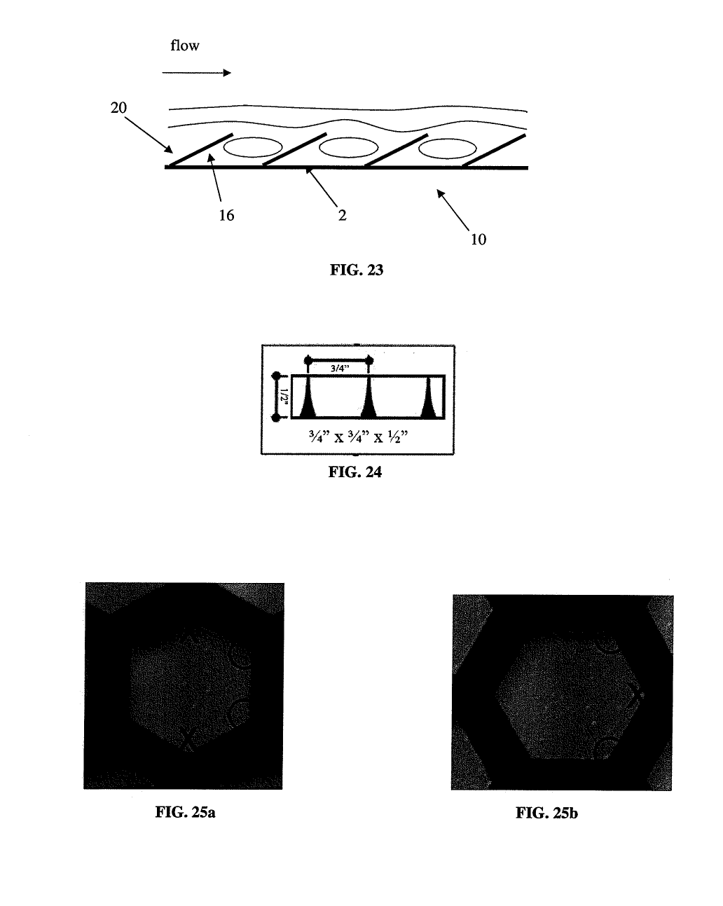

In another aspect, as illustrated in FIG. 23, at least a portion of the plurality of roughness elements 20 can extend at an acute angle relative to the underlying surface 2. In another aspect, the plurality of roughness elements 20 can extend at an angle of between about 5 degrees and 85 degrees relative to the underlying surface. In another aspect, the plurality of roughness elements can extend at an angle of between about 30 degrees and 60 degrees relative to the underlying surface 2. In still another aspect, the plurality of roughness elements 20 can extend at an angle of about 45 degrees relative to the underlying surface.

In one aspect, it is contemplated that positioning at least a portion of the plurality of roughness elements at an acute angle relative to the underlying surface can potentially create a larger cavity 16 than a plurality of roughness elements positioned substantially normal to the underlying surface. In another aspect, for air flow over the plurality of roughness elements on the order of 2 m/s, the Re can be calculated to be on the order of 10 based on cavity length, as can be appreciated.

In still another aspect, the boundary layer thickness at a distance of approximately 0.5 cm from the leading edge of an array 10 of roughness elements 20 can have Re=700 and δ=1 mm at a fluid speed of approximately 2 m/s. In another aspect, the boundary layer thickness at a distance of approximately 5 cm from the trailing can have Re=7×10³ and δ=3 mm at a fluid speed of approximately 2 m/s. Thus, it is contemplated that an embedded geometry with cavities on the order of 1/10^{th} the boundary layer thickness can interact with the viscous shear flow occurring at the surface of the array of roughness elements.

In this embodiment, at lower Re, the array 10 of roughness elements 20 extending at an acute angle relative to the underlying surface can be arranged substantially linearly such that a plurality of spanwise channels comprise the embedded cavity. In one aspect, the angled roughness elements can also be substantially aligned in the streamwise direction (i.e., not staggered). In another aspect, the plurality of roughness elements can also be arranged to give the path of least resistance to the flow over the surface, as illustrated in FIG. 23. As can be appreciated, because of the lower Re and laminar flow above the cavities, the cavities can have a length greater than their heights and still form a stable, embedded vortex, thereby helping to maximize the skin friction reduction potential.

In another aspect, however, it is contemplated that the roughness elements 20 can be aligned such that the peaks of the roughness elements of each adjacent ridge 12 can be staggered, as previously discussed, giving the surface a three-dimensional yet repeatable pattern. This can, in one aspect, create a roof shingle-like pattern of roughness elements that can allow adaptation to a curved, irregular underlying surface.

In another aspect, an array of roughness elements can be disposed on and extend therefrom the underlying surface. In this aspect, the roughness elements can be positioned substantially transverse to the flow of fluid across the wall surface, and substantially linearly in successive ridges of roughness elements. In another aspect, a plurality of embedded cavities can be formed therebetween the successive ridges of roughness elements and the flow of fluid across the wall surface can form at least one cavity vortex therein each cavity of the plurality of embedded cavities.

In another aspect, the roughness elements of successive ridges can be offset in a direction substantially parallel to the direction of fluid flow on the at least a portion of the wall surface. Alternatively, the roughness elements of successive ridges can be aligned in a direction substantially parallel to the direction of fluid flow on the at least a portion of the wall surface.

In another aspect, re-aligning the geometry can increase surface drag under reversed flow (such as in the case of a leading edge vortex or separation region). In another aspect, when the roughness elements are aligned transverse to the fluid flow, the surface drag can be reduced below that of a flat surface.

In one aspect, the angle between the plurality of roughness elements and the underlying surface can allow for a preferential flow direction to the surface 2. In another aspect, it is contemplated that the surface 2 can aid in controlling the unsteady flow and leading edge vortex formation occurring over the array 10 of roughness elements that would occur, for example, during flapping flight. Moreover, in this role, it is contemplated that the surface can also aid in preventing separation at the trailing edge of the array of roughness elements 20, thereby resulting in longer attachment of the leading edge vortex (without stall) and higher lift and thrust production. Thus, for example, this microgeometry can be useful on the wings of flapping micro-air vehicles (MAVs) and the like.

### Experimental

### Turbulent Boundary Layer Flow Over Embedded Hexagonal Cavities

In this experiment, a hexagonal lattice was placed on a flat plate to create hexagonal cavities. These hexagonal cavities were embedded onto the flat plate and placed in the water tunnel to investigate the flow over the cavities. The hexagonal cavities were studied at two different orientations to compare the boundary layer flow over them. Also a flat plate section was tested to compare flat plate boundary layer characteristics to those forming above the cavities.

The objective was to study the effect of the hexagonal cavities on a turbulent boundary layer under conditions where the cavity depth was comparable in magnitude to the boundary layer thickness. It is contemplated that the influx and efflux of flow into and out of the cavities, energizing the cavity vortices, can help to prevent the boundary layer separation and possibly lead to turbulence augmentation such that higher momentum is achieved close to the surface as compared to a flat plate turbulent boundary layer. Experimentally, the partial slip velocities of the embedded cavities were measured and the two orientations were compared at different downstream distances. When the boundary layer profiles and Reynolds stresses within the turbulent boundary layer were compared to the profiles over a flat plate at the same downstream distance, variation in these profiles with cavity orientation was observed experimentally.

All experiments were performed in the water tunnel facility at the University of Alabama. A 1,500 gallon water tunnel having a test section 75 cm high, 41 cm wide, and 2.75 m long was used. Made by Rolling Hills Research Corporation, the Eidetics 1520-EXT low freestream turbulence was calculated to be an average of 0.41% at 1 cm/s. For all experiments, Digital Particle Image Velocimetry (DPIV) was used to characterize the flow over the microgeometries. Willert and Gharib (1991) reported an uncertainty of approximately 1% in translational displacements, and approximately 5% in rotational displacements for optimal seeding. The DPIV system consisted of the following components: a Quantronix Falcon 30 Nd:YLF laser, a Basler A504K high speed digital camera, a Dell Precision workstation with a National Instruments frame grabber (PCIe-1429) with an extension board. The images were acquired using NI LabVIEW software and were processed via Pixelflow software which uses a correlation method similar to that reported in Willert & Gharib (1991). The camera used was an 8-bit Basler A504k with a Nikkor 105 mm lens. The laser and the camera were set at the same frequency of 400 Hz. The number of image pairs used for the overall turbulence averaging for each trial was 1,200. Finally, the water flow was seeded with silver coated hollow glass particles having a specific gravity of 1.6 and an average diameter of 14 μm.

An embedded, hexagonal cavity model was tested at two different orientations (see FIGS. 25a and 25b). The test section consisted of the following sections is this order: (a) leading flat plate 91.4 cm in length, (b) hexagonal cavity model measuring 61 cm long, and a (c) trailing flap to insure the leading edge top surface streamline passed parallel to the flat plate model. The leading edge to the flat plate had the optimal elliptical shape prescribed by Fransson. The flow was tripped upstream at a location of 46 cm upstream of the model to form a turbulent boundary layer. Tests were run at 14.2 cm/s, 21.5 cm/s and 26 cm/s, which corresponds to a local Re in the boundary layer at the start of the model of 1.3×10⁵, 1.96×10⁵ and 2.37×10⁵ respectively.

To build the hexagonal cavity model, a hexagonal lattice was placed on top of a clear Plexiglas plate. The hexagonal lattice was 30.5 cm wide, 61 cm long, and 1.27 cm deep. The cavities attached to the modular section so that the tops of the cavities were flush with the flat plate. The cavities were also flush with another flat plate section that was 30.5 cm wide and 61 cm long which was positioned above the hexagonal cavity model. In one aspect, the hexagonal cavities can be 1.91 cm (¾ inch) from wall to wall at the top of the cavity and have a depth of 1.27 cm (½ inch) as shown in FIG. 24. The cavities have a parabolic profile, making the bottom of the cavities smaller than the top. The first trials were run with the cavities positioned as in FIG. 25a. This orientation is referred to herein as Hex 1. The other trials were run with the cavities rotated 30 degrees as shown in FIG. 25b. This orientation is referred to herein as Hex 2.

First, dye visualization was performed under laminar conditions to identify the injection/ejection points for each orientation based on geometrical considerations. Dye was injected into a slit upstream of the cavities. The dye was carried into the boundary layer and over the hexagonal cavities. Some of the dye entered the cavities and a UV lamp was used to illuminate the dye for visualization purposes. Images were taken of the dye in the cavities to analyze the motion of the fluid inside the cavities for both orientations of the hexagonal model.

The Re_{d} is the Reynolds number based on cavity depth, d, and the freestream velocity δ is the boundary layer thickness. The parameter δ/d is used to determine if the Kelvin-Helmholtz (K-H) instability will affect the flow. For the trials the value of δ/d was approximately 2.4. Yao et al. showed that for a ratio of δ/d=2.1 and a Reynolds number based on cavity height of 3200, the K-H instability did not affect the boundary, layer flow. Therefore, the Reynolds number in this experimental research would not be affected by the K-H instability forming in the shear layer over the tops of the cavities. Trials were run at velocities corresponding to Re_{d} of 1,800, 2,600 and 3,300.

There were two main objectives of this study. First, to qualitatively study the flow inside the cavities using dye visualization, noting similarities and differences in the two geometries and second, to study a fully turbulent boundary layer over the embedded cavities, comparing partial slip velocities, boundary layer profiles, and Reynolds stress.

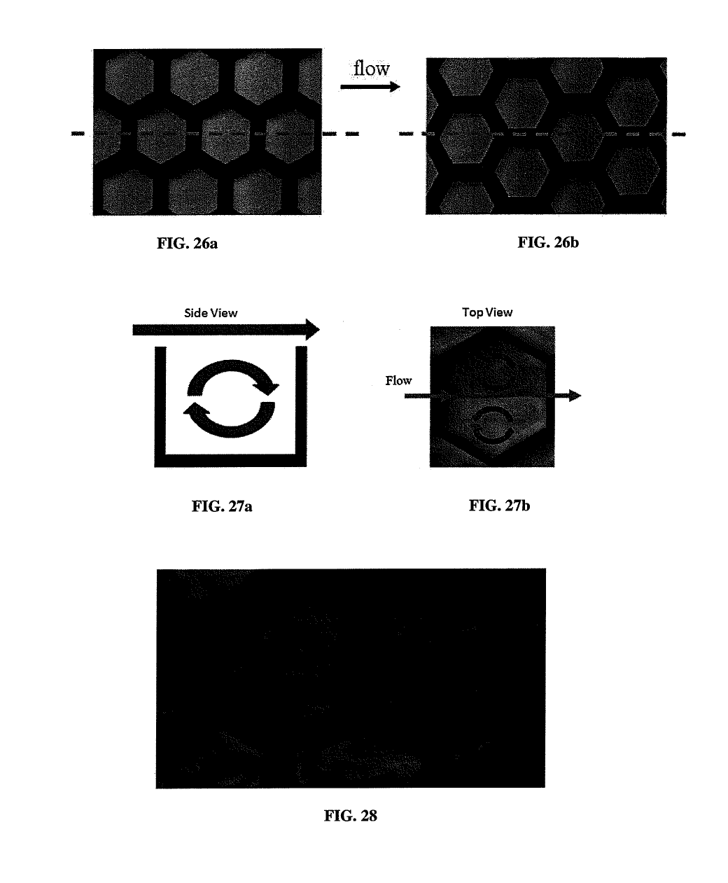

Dye visualization was used to show the flow inside the cavities under laminar flow conditions. Using pressurized dye ports, a reservoir behind the upstream flat plate was filled with dye. The UV fluorescent dye entered the boundary layer flowing over the flat plate, and subsequently the cavities, via a 1.6 mm horizontal slit located 27.3 cm upstream of the cavities. As the first dye started flowing over the embedded cavities, the locations that the dye entered the cavities were readily obtained visually. For the first orientation (Hex 1), the dye entered the cavities from the bottom and top of the cavity as shown with an “X” in FIG. 26a. For the second orientation (Hex 2), the dye entered the cavities at the downstream point as shown in FIG. 26b. It was clear that the fluid was being ejected from the first orientation at the top and bottom of the downstream wall as shown with a circle in FIG. 26a. The ejection of fluid from the second orientation was at the top and bottom downstream corners as shown in FIG. 26b. The different injection and ejection locations for the two geometries suggest that the orientations can interact differently with the boundary layer flow.

Once the dye entered the cavity, the flow associated with the cavity vortices could be observed. The flow over the cavity causes a primary vortex in both configurations that rotates clockwise when the freestream flow is left to right as shown in FIG. 27a. This primary vortex resembles most cavity flows; the hexagonal shape did not alter this main rotation. Similar to flow in circular cavities (dimples), secondary vortices were present and were visible using dye visualization. With respect to the flow over the cavity, the right half of the cavity rotates counter-clockwise, while the left half of the cavity rotates clockwise as shown in FIG. 27b. The upper half of the horseshoe vortex and the lower half of the vortex did not appear to interact. FIG. 28 illustrates where the secondary rotation and some injections and ejection points can be observed, according to this aspect.

For the Hex 1 and Hex 2 geometries, trials were run in which the boundary layer was tripped to turbulence using a rectangular rod placed flat on the leading section, which protruded 0.5 cm from the wall. The rod was placed 12 inches from the leading edge, which meant that it was 24 inches upstream of the embedded cavities. The rod was placed this far upstream to allow for the boundary layer to be fully turbulent once it reached the embedded cavities. Before each trial, dye visualization was used to confirm that the boundary layer was completely turbulent. The resulting turbulent flow above the cavities induced large-scale injections/ejections of the fluid into/out of the cavities and a corresponding increase in Reynolds stress.

The time-averaged partial slip velocities were acquired along the centerline of symmetry for each geometry. Data for various cross sections moving towards the sidewalls was also acquired showing that the magnitude in the partial slip velocities decreased towards the edges of the cavities such that maximum partial slip occurred along the cavity centerlines. For instance, in the Hex 1 orientation, the partial slip velocities very near the cavity sidewalls ranged from 35-60% of the centerline velocities.

Data was extracted at a location of 1.8 mm above the cavities to discern the time-averaged vertical velocity above the cavities. It was found that above the front half of the cavities this value was positive (indicating on-average upwards velocity), reaching about 0.4% of the freestream velocity for example over the 2^{nd} cavity in the Hex 2 case at Re_{d}=2,600. Over the downstream half of the cavity the value went negative, and peaked at about 0.8% of the freestream velocity for the same Hex 2 case. These results indicate that fluid ejections primarily take place over the upstream portion of the cavity while fluid injections occur over the downstream half of the cavity.

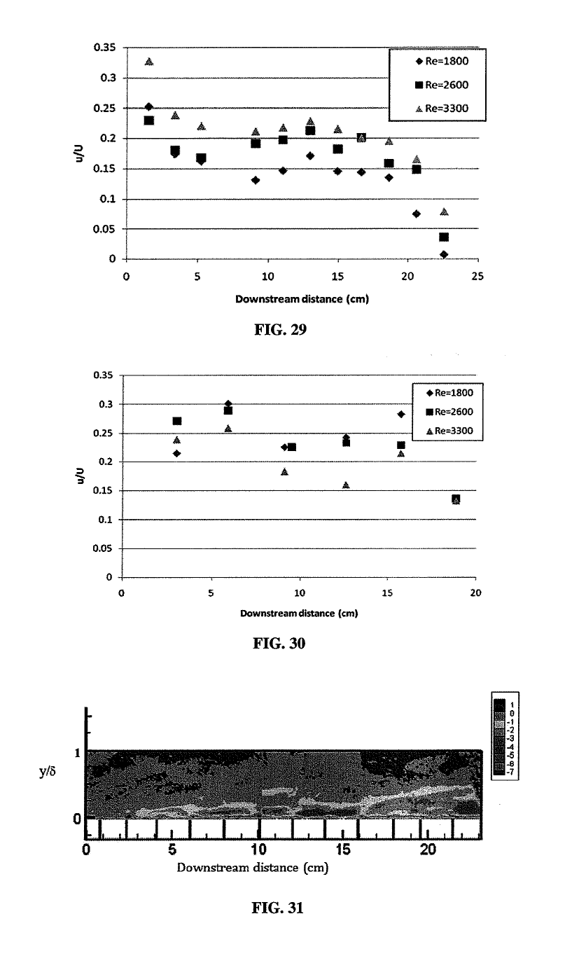

FIG. 29 shows the time-averaged, maximum partial slip velocities occurring over each cavity for the Hex 1 orientation trial at three different Re based on cavity depth. FIG. 30 shows the partial slip velocities above each cavity for the Hex 2 orientation trial. As illustrated in FIG. 29, the partial slip velocities for the Hex 1 orientation increased with increasing Reynolds number. However, the partial slip velocities for the Hex 2 orientation did not increase as much, staying in the range of 20% of the freestream velocity for most of the trials. This suggests that the Hex 1 orientation is more dependent on Reynolds number, whereas the Hex 2 orientation acts more consistently indicating greater Re independence.

For turbulent flows, the Reynolds stress data ( u̅′̅v̅′̅) above both orientations was extraced from the DPIV data. The Reynolds stress indicates the mixing of high momentum and low momentum fluid. FIG. 31 shows the Reynolds stress occurring in the boundary layer above the Hex 1 orientation. The partitions between each cavity have been drawn on the plot to visualize the location of the cavities. As shown in FIG. 31, the Reynolds stress is increasing above the cavities, which indicates that the cavities are causing a mixing of high momentum fluid and low momentum fluid. The largest (negative) Reynolds stress is found above the 7^{th} cavity.

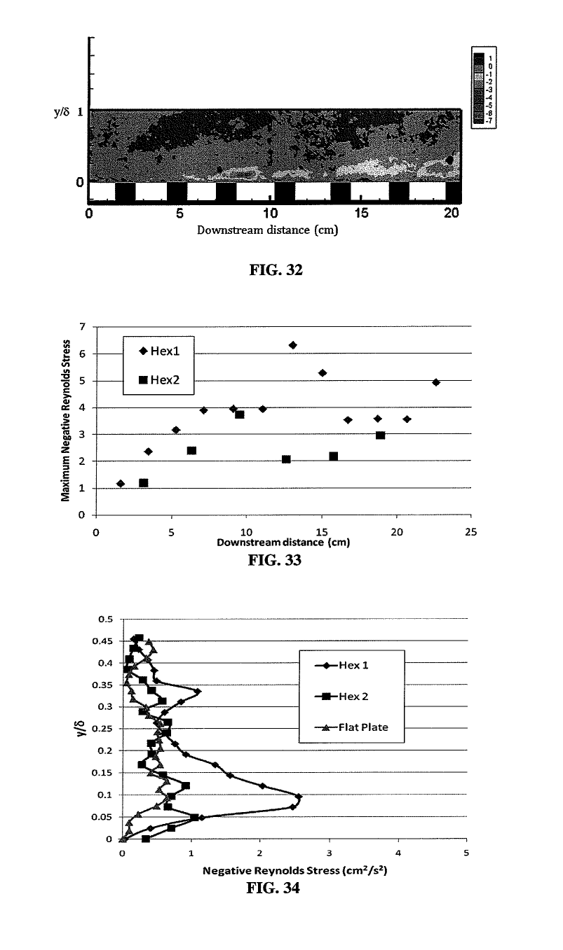

For the Hex 2 orientation, the Reynolds stress is shown in FIG. 32. The Reynolds stresses do not match up as well with the tops of the cavities as for the Hex 1 orientation. The overall magnitude of the Reynolds stress is smaller for the Hex 2 orientation than for the Hex 1 orientation. To compare the two orientations, the maximum (negative) Reynolds stress above each cavity as a function of downstram distance is plotted in FIG. 33. The difference could partly be due to the selection of the cross section sampled. For example, the cross section of the Hex 2 orientation was taken over some of the cavities above and parallel to a side wall on every other cavity. However, as illustrated in FIG. 26b, this wall is located in possible regions where fluid is being ejected from the cavities. In fact, in FIG. 32, it is above these walls where often increases in Re stress magnitudes are measured. Overall the Hex 1 orientation had higher Reynolds stresses than the Hex 2 orientation. FIG. 33 shows the maximum Reynolds stress magnitude extracted above each cavity and plotted as a function of downstream distance. Again it is clear that the Hex 1 orientation has higher values. Also, over the first few cavities the value begins close to that of the flat plate value and then increases with a maximum occurring in the middle of the model; this occurs over the 7^{th} cavity in the Hex 1 orientation and over the 3^{rd} cavity in the Hex 2 orientation.

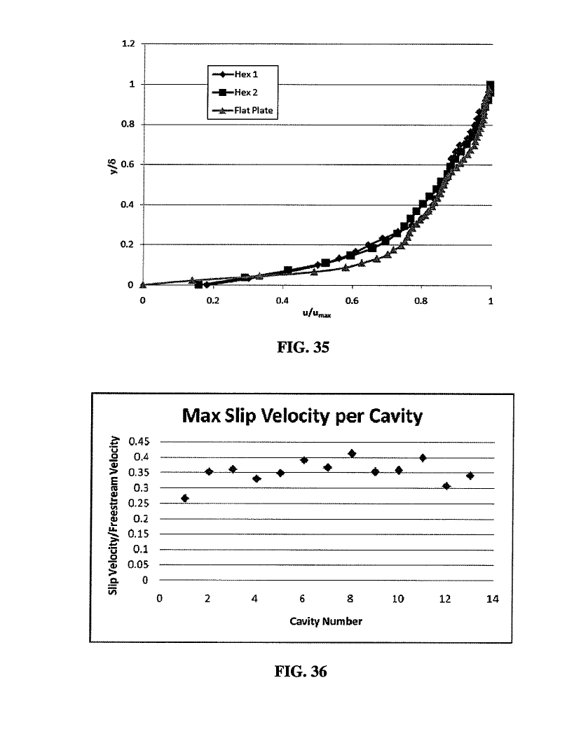

FIG. 34 shows profiles of the Reynolds stress magnitudes at three different downstream distances. The profiles show visually again that the Reynolds stress over the Hex 1 orientation model is larger than the Hex 2 orientation model. The typical flat plate Re stress profile was confirmed where the highest values are seen in a region close to the wall or intermediate layer. The data above the cavities indicates that Re stress is increased as well in this same region to higher magnitudes, but an increase is also observed in the outer layer closer to the free stream flow. This additional interaction and exchange of momentum is confirmed by examining the time-averaged velocity profiles such as the one shown in FIG. 35. Here, it is evident that the flow adjacent to the cavities has higher momentum due to the partial slip velocity boundary condition above the cavity. However, further away from the wall, and in the majority of the boundary layer, the flow above the cavity models exhibits lower momentum. This must be the case if overall the cavities actually increase the drag over the surface due to cavities capturing high momentum fluid and ejecting lower momentum fluid.

The first objective of this experimental study was to qualitatively describe the motion of the fluid in the embedded hexagonal cavities. It was shown that the fluid kept the primary cavity flow rotation of the top of the cavity flowing to the right (along the direction of the boundary layer flow) with reverse flow at the cavity bottom to sustain a primary, embedded cavity vortex with the same sign of vorticity as that in the boundary layer. Also, a secondary rotation was seen in that the left half of the cavity rotated clockwise and the right half of the cavity rotated counter-clockwise with respect to the freestream flow.

There was no significant difference in the primary and secondary rotation of the flow between the two orientations studied, however the cavity inflow/outflow areas were observed and there was a difference between the Hex 1 and Hex 2 orientations. The inflows and outflows always occurred at a corner of the model, leading to the conclusion that the cavity flow is more likely to be interacting with the boundary layer flow at the points where there is a meeting of two walls. Also, the fact that there was a difference in the influx/efflux points between the two orientations suggests that there can be a difference in the behavior of the orientations. The locations of the injections/ejections of the Hex 2 orientation seemed to be more organized than the Hex 1 orientation. This suggests that Hex 2 flow field is more consistent with respect to inflow/outflow location points.

At the cross sections compared, the Hex 1 orientation model has higher Reynolds stresses than the Hex 2 orientation and flat plate trials. This would indicate that the Hex 1 orientation achieves greater mixing. However, if the magnitude of the partial slip velocities is the primary indicator of higher momentum closer to the wall, then the Hex 2 orientation showed less Re dependence in maintaining higher partial slip velocities.

The partial slip velocities decreased with downstream distance over the model. However, the Reynolds stresses were smaller toward the beginning of the model even where the partial slip velocities above the first few cavities were between 20 to 30% of the freestream velocity. Large negative Reynolds stresses indicate mixing of fluid. But these results indicate that large Reynolds stresses do not correspond to the region of highest partial slip velocities; in fact the opposite is the case.

Thus, it is contemplated that locally applying an embedded cavity geometry only in a region where incipient separation exists can result in the increase in momentum needed to prevent flow separation via the formation of the partial slip velocities. In one aspect, patterning a large region over a surface may not be advantageous. In one aspect, small regions of embedded cavities can be used to locally increase the mometum in the boundary layer close to the wall. In another aspect, in order to control separation, the desired microgeometry can be applied in a localized region where separation is imminent instead of covering the whole surface of an object. In still another aspect, several patches of microgeometry can be applied subsequently at various downstream distances to prevent separation. In another aspect, an embedded cavity geometry can be applied to at least portions of a wall surface so that the wall surface is at least partially covered with an embedded cavity geometry. In another aspect, an embedded cavity geometry can be applied to at least portions of regions of a wall surface so that regions of the wall surface are at least partially covered with an embedded cavity geometry. As can be appreciated, this can be a more cost efficient approach than covering the entire surface. In another aspect, spacing and sizing of the embedded cavity geometry and the localized region(s) to which it will be applied can vary for each application.

It is contemplated that as the flow begins to reverse in a small region above the embedded cavity geometry, the flow reversal can locally bristle the roughness elements and instead localized regions of reversal (embedded cavity vortices) form within the cavities. The embedded vortices then work to impose partial slip velocities above them allowing for increased momentum close to the surface. This occurs only on a small region of the overall area of the surface and works to locally prevent/inhibit flow separation allowing for decreased drag and increased maneuverability while moving through the fluid.

### Turbulent Boundary Layer Encountering a 2D Embedded Cavity Surface

All tests for this study were conducted in the University of Alabama water tunnel facility with a freestream velocity of 20 cm/s. The water tunnel is an Eidetics 1520-EXT low freestream turbulence model manufactured by Rolling Hills Research Corporation. The embedded cavity model was a grooved Plexiglas plate with plastic walls placed into the grooves to create the boundaries of the cavities. The model was 26 cm long by 61 cm wide, with 13 consecutive square cavities (2 cm on a side) created by plastic dividers 0.16 cm ( 1/16 in) thick. Clear plastic sidewalls were placed along the edge of the cavities in order to prevent fluid from flowing into/out of the cavities from the sides. Ahead of the cavities the boundary layer was grown over a flat plate 91 cm in length with an elliptic leading edge and trailing edge flap to insure smooth flow over the leading edge. This resulted in a local boundary layer Reₓ=1.82×10⁵ and a turbulent, tripped theoretical boundary layer thickness, δ, of 2.56 cm. The cavities were embedded into the model or located below the y=0 plane of the flat plate preceding the cavities (i.e. the tips of the plastic dividers ended at y=0); this resulted in the least amount of disturbance to the oncoming flow and minimal profile drag. A turbulent boundary layer resulted by tripping the flow further upstream of the embedded cavities on the flat plate.

The flow was measured using a Time-Resolved Digital Particle Image Velcoimetry (TR-DPIV) system. The high speed camera, Basler A504K, is capable of 500 fps at full resolution of 1K×1K and allows for time-resolved measurements of the flow field. The flow was seeded with 10 μm silver-coated hollow glass spheres and then illuminated by a laser sheet generated by a Quantronix Falcon 20 mJ Nd:YLF laser. Image acquisition was controlled through LabVIEW on a high-performance PC, while post-processing of the images to obtain the velocity fields and other turbulence quantities was performed using Pixelflow software. In all cases a minimum of 2400 image pairs were averaged to obtain turbulent statistics.

The experiments were designed to investigate several aspects of the resulting flow field including the average and peak partial slip velocities over the cavities, boundary layer profiles and Reynolds stress distributions, all as a function of downstream distance.

The time-averaged flow inside a single cavity resulted in the formation of an on-average embedded vortex. The formation of this flow resulted in a partial slip condition imposed on the outer flow when mixing is not occurring with the cavity at this location; on average this partial slip flow runs parallel to y=0 which implies no on-average vertical component of flow into or out of the cavity. Partial slip velocity varied across the cavity, reaching a maximum at a location approximately 70% downstream of the upstream cavity wall. Mixing was intermittent and irregular, consisting of high momentum flow entering and low momentum flow ejecting from the cavities.

The partial slip velocities were studied as a function of downstream distance, and when extracted from the time-averaged data are shown in FIG. 36. The partial slip velocity appears lowest (around 0.26 U), but not negligible, in the first cavity and then increases to fluctuate around 0.34-0.41 U in subsequent cavities. A slight drop off in the value did appear to take place towards the end of the model, but further experiments with a greater number of cavities would be needed to corroborate this trend. This drop off could be attributed to a relaxation in the effect of the turbulent boundary layer interacting with the embedded cavity surface, or could be a result from the presence of the flat plate further downstream of the model.

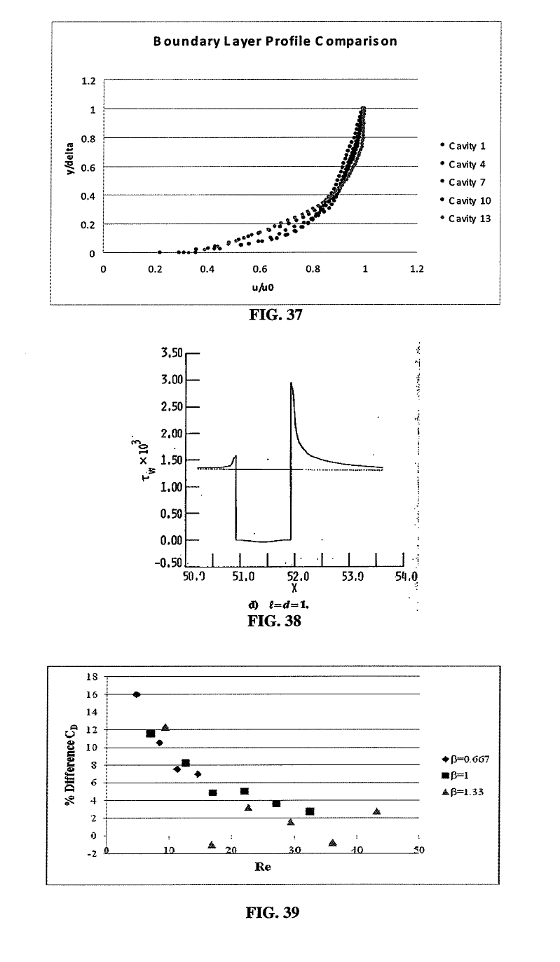

Next, the time-averaged boundary layer profiles resulting from the turbulence augmentation and partial slip condition over the cavities was analyzed as this provided the best indication of separation control potential. FIG. 37 shows the boundary layer profiles extracted at the midpoint above the cavities for the 1^{st}, 4^{th}, 7^{th}, 10^{th} and 13^{th} (final) cavities in comparison to one another. When compared to a flat plate, an interesting trend in the data was observed; as the flow initially encountered the cavities, an increase in momentum throughout almost the entire profile (except for the region closest to the freestream) was clearly evident over the 1^{st} cavity. As the flow proceeded downstream, the flow adjacent to the wall remained above zero velocity due to the partial slip condition over the cavities. However with increasing downstream distance, the flow slightly further away from the wall returned towards values similar to that of the flat plate, and by the 10^{th} cavity actually decreased in momentum as compared to the flat plate. However, the trend in the boundary layer region furthest away from the wall appeared to be of opposite effect, an increase in momentum as compared to the flow over the first cavity and flat plate is evident.

Results suggest that ahead of the embedded cavities the beneficial effects leading to separation control are felt within the boundary layer as observed in the boundary layer profile upstream. It is contemplated that the mechanism leading to this increase in momentum observed closer to the wall is the result of the mixing of high-momentum flow within the first few cavities. As this high-momentum flow is allowed to enter into the cavities the effect of the cavities drawing in this high momentum fluid is even felt upstream. Proceeding downstream the effect of low momentum fluid being ejected from the cavities, and the net overall surface drag increase, is made manifest in the decrease in momentum within the boundary layer profile in the region just above the wall as compared to the flat plate. Another effect is that the higher momentum fluid downstream appeared to be staying further away from the wall. No significant effect on boundary layer growth was observed other than the flow over the cavities exhibited a slightly thicker boundary layer. However, adjacent to the wall the presence of the embedded vortices within the cavities still led to a partial slip effect to the flow very near the wall.

It is contemplated that as cavity depth/boundary layer depth increases, the size of the turbulent structures persisting near the wall decreases and thus mixing effects would decrease. However, at higher Re the partial slip velocities (percent of free stream U) should increase, and this trend could allow for the maintenance of sufficient partial slip for separation control on a surface where δ/d˜10 or greater. It is also noted that the presence of the first cavity induces a slightly favorable pressure gradient upstream which is of course beneficial to controlling flow separation. All of these results indicate that locally placing an embedded cavity geometry only in a region where separation is imminent is more effective than fully patterning a surface where such applications are feasible (i.e. surfaces with prescribed regions of flow separation, unlike the golf ball).

### Drag Reduction Over Embedded Cavities for Low Re Flows

This experiment focused on patterning a surface with transverse grooves with walls of minimum thickness. As the flow passes over the grooves, an embedded cavity vortex is formed allowing the outer flow to pass over the cavities, and the no slip condition is only imposed on the flow at the tops of the minimally thick walls. As the flow passes over the embedded vortex, a partial slip condition is felt on the outer flow. Additionally, the flow reversed in the cavity imposes a shear stress at the bottom of the cavity which acts as a thrust (additionally reducing the net drag of the surface). The results for low Reynolds number Couette flow show the potential for drag reduction at low Re (based on the height of the viscous layer, which for Couette flow is the height of the channel and for external flows a characteristic length scale of the boundary layer) is available. This would have potential applications to MAVs as well as micro-fluidic applications in gases

In one aspect, it is contemplated that the cavity can have a cavity ratio of length in the fluid flow direction to depth of approximately 2:1. This ratio can yield the maximum length at low Re for maintaining an embedded vortex within the cavity and thus maximizes the drag reduction. However, in another aspect, it is also contemplated that the cavity ratio can be at least 1:1. In various other aspects, the cavity ratio can be at least about 0.1:1, 0.25:1, 0.5:1, or 0.75:1. In still other aspects, the cavity ratio can be at least about 3:1, 4:1 or 5:1.

Using a Couette flow facility with the working fluid as high viscosity mineral oil we have experimentally demonstrated a drag reduction for square embedded cavities. Couette flow consists of the flow trapped between a moving belt (moving at speed U) and the surface on which the drag is being generated. The Re=Uh/ν based on the gap height, h. β is the non-dimensional gap height given with respect to the cavity length, d, so that β=h/d. An 8% or greater reduction in the non-dimensional drag coefficient, C_{D}, is realized for Re<10 as compared to that of a flat surface.

In one aspect, measurements have looked at a range of Re=5-50 and thus inertial effects begin to take effect in the flow. However, for Re<15 a significant drag reduction is still realizable as compared to the flat plate. Thus, for MAV applications a reduction of ˜30% in the skin friction can be realizable. In addition, if the drag is increased in the region where flow is reversed (reorient the pattern 90 degrees with respect to the flow so that it is passing parallel to the cavity walls) a net effect in altering the drag can be realized such that instead of a drag an overall average thrust force could actually be realized while also controlling the size of the leading edge vortex. Also, it is contemplated that angling the cavities walls to between about 20 and 70 degrees, including about 25 degrees, about 30 degrees, about 35 degrees, about 40 degrees, about 45 degrees, about 50 degrees, about 55 degrees, about 60 degrees, and about 65 degrees can have the added benefit of: (1) further increasing the drag reduction case for flow over the cavities by letting the highest region of shear located on the downstream cavity wall contribute to a net thrust force for the surface; (2) further increasing the drag augmentation for the flow parallel to the cavity walls by increasing the surface area; and (3) giving the flow a preferred flow direction and path of least resistance which could control the reattachment point of the leading edge vortex for optimal lift and thrust generation in both flapping and gliding flight.

Thus, an embedded cavity geometry at high Re works to delay flow separation and reduce pressure drag. At low Re an embedded cavity geometry works to decrease skin friction.

The preceding description is provided as an enabling teaching in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. The corresponding structures, materials, acts, and equivalents of all means or step plus function elements in the claims below are intended to include any structure, material, or acts for performing the functions in combination with other claimed elements as specifically claimed.

Accordingly, those who work in the art will recognize that many modifications and adaptations to the present invention are possible and can even be desirable in certain circumstances and are a part of the present invention. Other embodiments of the invention will be apparent to those skilled in the art from consideration of the specification and practice of the invention disclosed herein. Thus, the preceding description is provided as illustrative of the principles of the present invention and not in limitation thereof. It is intended that the specification and examples be considered as exemplary only, with a true scope and spirit of the invention being indicated by the following claims.

What is claimed is:

1. An aerodynamic or hydrodynamic wall surface configured to modify the interaction of a boundary layer of a fluid with the wall surface, comprising:
a plurality of roughness elements disposed on and extending therefrom the wall surface in an array, wherein each roughness element has a front, upstream surface and an opposing rear, downstream surface, wherein the plurality of roughness elements are positioned substantially transverse to the flow of fluid across the wall surface, wherein the roughness elements are positioned in successive, substantially linear ridges of roughness elements to define a plurality of embedded cavities therebetween the successive ridges of roughness elements, wherein the flow of fluid across the wall surface forms at least one cavity vortex therein each embedded cavity, and wherein the at least one cavity vortex reduces friction between the fluid and the wall surface.

2. The wall surface of claim 1, wherein at least a portion of the wall surface is a curved surface.

3. The wall surface of claim 2, wherein the roughness elements of successive ridges are offset in a direction substantially parallel to the direction of fluid flow on the curved surface.

4. The wall surface of claim 3, wherein at least one roughness element of the plurality of roughness element extends therefrom the wall surface at an acute angle relative to the to the portion of the wall surface to which the at least one roughness element is connected

5. The wall surface of claim 4, wherein at least one roughness element of the array of roughness element extends therefrom the wall surface at an angle between 30 and 60 degrees relative to the portion of the wall surface to which the at least one roughness element is connected.

6. The wall surface of claim 4, wherein at least one roughness element of the array of roughness element extends therefrom the wall surface at an angle of about 45 degrees relative to the portion of the wall surface to which the at least one roughness element is connected.

7. The wall surface of claim 1, wherein the roughness elements extend substantially normal to the underlying wall surface.

8. The wall surface of claim 1, wherein respective roughness elements of adjacent, successive ridges are aligned on an axis substantially parallel to the direction of fluid flow.

9. The wall surface of claim 1, wherein respective roughness elements of adjacent successive ridges are offset relative to the direction of fluid flow.

10. The wall surface of claim 1, wherein a height of at least one embedded cavity of the plurality of embedded cavities is about 1/10^{th} a boundary layer thickness.

11. The wall surface of claim 1, wherein the plurality of roughness elements is disposed on a portion of the wall surface where boundary layer separation is imminent.

12. The wall surface of claim 11, wherein the plurality of roughness elements comprises a plurality of arrays of roughness elements, and wherein the arrays of roughness elements are disposed on a plurality of portions of the wall surface where boundary layer separation is imminent.

13. The wall surface of claim 1, wherein each embedded cavity of the plurality of embedded cavities has a ratio of length in the direction of fluid flow to depth of at least 1:1.

14. The wall surface of claim 13, wherein the ratio of length in the direction of fluid flow to depth of at least 2:1.

15. The wall surface of claim 14, wherein the fluid has a Re of between about 5 and 50.

16. The wall surface of claim 1, wherein at least one embedded cavity of the plurality of embedded cavities imposes a shear stress at a bottom of the embedded cavity that acts as a thrust to the wall surface.

17. The wall surface of claim 1, wherein the front, upstream surface of each roughness element has a curved, convex cross-sectional shape relative to the flow of fluid across the wall surface.

18. The wall surface of claim 17, wherein the rear, downstream surface of each roughness element has a curved, concave cross-sectional shape relative to the flow of fluid that is configured to promote the recirculation of the flow within the cavity and to act as a streamlining effect in both stabilizing and promoting an embedded vortex flow field.

19. The wall surface of claim 18, wherein a top of each roughness element is positioned at an acute angle relative to the wall surface such that the tops of the roughness elements do not protrude into the fluid flow substantially normal to the flow direction.

20. The wall surface of claim 18, wherein a radius of curvature of the rear, downstream surface of the roughness element is less than a radius of curvature of the front, upstream surface of the roughness element.

21. The wall surface of claim 18, wherein each roughness element comprises at least one riblet extending outwardly therefrom the front, upstream surface of the roughness element that is configured to aid in the formation and stability of cavity flows embedded between the roughness elements.

22. The wall surface of claim 21, wherein each riblet extends longitudinally from at or near a bottom portion of the roughness element, proximate a base of the roughness element, to at or near a top of the roughness element.

23. The wall surface of claim 22, wherein each riblet extends substantially transverse to the wall surface.

24. The wall surface of claim 22, wherein the at least one riblet comprises a plurality of riblets.

25. The wall surface of claim 21, wherein each roughness element comprises at least one riblet extending outwardly therefrom the rear, downstream surface of the roughness element, and wherein each riblet extends substantially longitudinally.

26. The wall surface of claim 24, wherein a trough is defined therebetween adjacent riblets that are recessed from the respective tips of the riblets.

27. The wall surface of claim 26, wherein the front, upstream portion of each roughness element has an edge surface that extends between respective riblets that are positioned adjacent to the sides of the roughness element.

28. The wall surface of claim 27, wherein the edge surface can be substantially planar.

29. The wall surface of claim 27, wherein at least a portion of the edge surface can be curved, and wherein a radius of curvature of the edge surface is greater than a radius of curvature of the trough of the roughness element.

30. An aerodynamic or hydrodynamic wall surface configured to modify the interaction of a boundary layer of a fluid with the wall surface, comprising:
means for reducing drag between the fluid and the wall surface comprising a plurality of roughness elements disposed on and extending therefrom at least a portion of the wall surface, wherein the plurality of roughness elements are positioned substantially transverse to the flow of fluid across the wall surface, wherein the roughness elements are positioned in successive, substantially linear ridges of roughness elements to define a plurality of embedded cavities therebetween the successive ridges of roughness elements, wherein the roughness elements of successive ridges are offset in a direction substantially parallel to the direction of fluid flow on the at least a portion of the wall surface, and wherein the flow of fluid across the wall surface forms at least one cavity vortex therein each embedded cavity.

31. The wall surface of claim 30, wherein the means for reducing drag is applied to at least a portion of the wall surface where boundary layer separation is imminent.

32. The wall surface of claim 31, wherein at least one roughness element of the array of roughness element extends therefrom the wall surface at an angle between 30 and 60 degrees relative to the wall surface.

33. The wall surface of claim 31, wherein at least one roughness element of the array of roughness element extends therefrom the wall surface at an angle of about 45 degrees relative to the wall surface.

35. The wall surface of claim 30, wherein the plurality of roughness elements comprises a plurality of arrays of roughness elements, and wherein the arrays of roughness elements are disposed on a plurality of portions of the wall surface where boundary layer separation is imminent.
